(19) United States
(12) Patent Application Publication
(10) Pub. No.: US 2006/0001726 A1
(43) Pub. Date: Jan. 5, 2006

(54) Printable conductive features and processes for making same

(75) Inventors: Toivo T. Kodas, Albuquerque, NM (US); Mark Kowalski, Albuquerque, NM (US); Klaus Kunze, Albuquerque, NM (US)

Correspondence Address: Jaimes Sher, Esq.;Cabot Corporation, 5401 Venice Avenue, NE, Albuquerque, NM, 87113, US

(73) Assignee: Cabot Corporation, Albuquerque, NM (US)

(21) Appl. No.: 11/176,640

(22) Filed: Jul. 8, 2005

Related U.S. Application Data
(63) Continuation-in-part of application No. 10/265,351, filed on Oct. 4, 2002.
(60) Provisional application No. 60/327,620, filed on Oct. 5, 2001.

(51) Int. Cl. B41J 2/01

(52) U.S. Cl. 347/105

(57) ABSTRACT

Processes for forming conductive features from one or more inks and conductive features formed from the processes. In one aspect, the process includes a step of applying a first ink comprising a metal precursor to at least a portion of a first substrate to form an at least partially coated substrate. In a second step, the first ink is contacted with a reducing agent, optionally derived from a second ink, under conditions effective to reduce the metal in the metal precursor to its elemental form.

### CROSS REFERENCE TO RELATED APPLICATIONS

This application is a continuation-in-part of pending U.S. patent application Ser. No. 10/265,351, filed Oct. 4, 2002, which claims priority to Provisional Patent Application Ser. No. 60/327,620, filed Oct. 5, 2001, the entireties of which are incorporated herein by reference.

### FIELD OF THE INVENTION

The present invention relates to printable conductive features, and more particularly, to printable conductive features that may be formed by reacting a metal precursor with a reducing agent.

### BACKGROUND OF THE INVENTION

The electronics, display and energy industries rely on the formation of coatings and patterns of conductive materials to form circuits on organic and inorganic substrates. The primary methods for generating these patterns are screen printing for features larger than about 100 μm and thin film and etching methods for features smaller than about 100 μm. Other subtractive methods to attain fine feature sizes include the use of photo-patternable pastes and laser trimming.

One consideration with respect to patterning of conductors is cost. Non-vacuum, additive methods generally entail lower costs than vacuum and subtractive approaches. Some of these printing approaches utilize high viscosity flowable liquids. Screen-printing, for example, uses flowable mediums with viscosities of thousands of centipoise. At the other extreme, low viscosity compositions can be deposited by methods such as ink-jet printing. However, this latter family of low viscosity compositions is not as well developed as the high viscosity compositions.

Ink-jet printable conductor compositions have been described by R. W. Vest (Metallo-Organic Materials for Improved Thick Film Reliability, Nov. 1, 1980, Final Report, Contract #N00163-79-C-0352, National Avionic Center). The compositions disclosed by Vest included a precursor and a solvent for the precursor. These compositions were not designed for processing at low temperatures, and as a result the processing temperatures were relatively high, such as greater than 250° C.

U.S. Pat. Nos. 5,882,722 and 6,036,889 by Kydd disclose conductor precursor compositions that contain metallic particles, a precursor and a vehicle and are capable of forming conductors at low temperatures on organic substrates. However, the formulations have a relatively high viscosity and are not useful for alternative deposition methods such as ink-jet printing.

Attempts have also been made to produce metal-containing compositions at low temperatures by using a composition containing a polymer and a precursor to a metal. See, for example, U.S. Pat. No. 6,019,926 by Southward et al. However, the deposits were chosen for optical properties and were either not conductive or were poorly conductive.

U.S. Pat. Nos. 5,846,615 and 5,894,038, both by Sharma et al., disclose precursors to Au and Pd that have low reaction temperatures thereby conceptually enabling processing at low temperatures to form metals. It is disclosed that a variety of methods can be used to apply the precursors, including ink-jet printing and screen printing. However, the printing of these compositions is not disclosed in detail.

U.S. Pat. No. 5,332,646 by Wright et al. discloses a method of making colloidal palladium and/or platinum metal dispersions by reducing a palladium and/or platinum metal of a metallo-organic palladium and/or platinum metal salt that lacks halide functionality. However, formulations for depositing electronic features are not disclosed.

U.S. Pat. No. 5,176,744 by Muller discloses the use of Cu-formate precursor compositions for the direct laser writing of copper metal. The compositions include a crystallization inhibitor to prevent crystallization of copper formate during drying.

U.S. Pat. No. 5,997,044 by Behm et al. discloses a document, such as a lottery ticket, having simple circuitry deposited thereon. The circuitry can be formed from inks containing conductive carbon and other additives as well as metallic particles. It is disclosed that the inks can be deposited by methods such as gravure printing.

U.S. Pat. No. 6,238,734 by Senzaki et al. is directed to compositions for the chemical vapor deposition of mixed metal or metal compound layers. The method uses a solventless common ligand mixture of metals in a liquid state for deposition by direct liquid injection.

U.S. Patent Publications Nos. U.S. 2003/0124259 A1; U.S. 2003/0108664 A1; U.S. 2003/0175411 A1; U.S. 2003/0161959 A1; and U.S. 2003/0148024 A1, all to Kodas et al., the entireties of which are incorporated herein by reference, disclose various processes for forming conductive features through various printing processes including ink jet printing.

The need exists, however, for additional processes for fabricating conductive features at relatively low temperatures, e.g., less than about 200° C., while still providing adequate electrical and mechanical properties.

### SUMMARY OF THE INVENTION

In one embodiment, the present invention is directed to processes for forming conductive features. In one aspect, the process comprises the steps of: (a) applying a first ink comprising a metal precursor to at least a portion of a first substrate to form an at least partially coated substrate; and (b) contacting the first ink with a primary reducing agent under conditions effective to reduce the metal in the metal precursor to its elemental form.

In a preferred embodiment, the process further comprises the steps of: (c) applying a second ink comprising the primary reducing agent or a solution thereof, before step (a), to at least a portion of a surface of an initial substrate; and (d) at least partially drying the second ink on the initial substrate to form the first substrate, wherein the first substrate has the primary reducing agent disposed thereon. The first ink may be selectively applied to the first substrate in a predetermined pattern in step (a), and/or the second ink may be selectively applied to the initial substrate in a predetermined pattern in step (c).

In one aspect, the first substrate comprises a reducing agent layer and an underlying support layer, wherein the reducing agent layer comprises the primary reducing agent and has an external surface, and wherein the first ink is applied to at least a portion of the external surface in step (a).

In another aspect, the process further comprises the step of: (c) applying a second ink comprising the primary reducing agent to at least a portion of the at least partially coated substrate after step (a).

In another embodiment, the process further comprises the step of: (c) applying a second ink comprising the primary reducing agent to an initial substrate, prior to step (a), to form the first substrate.

In several other embodiments, the invention is to conductive features formed by the various processes of the present invention.

In another embodiment, the invention is to a reducing agent composition suitable for ink jetting, the reducing agent composition comprising a primary reducing agent dissolved in a solvent, wherein the reducing agent composition is capable of reducing a metal in a metal precursor to its elemental form, and wherein the reducing agent composition has a surface tension of from about 15 to about 72 dynes/cm and a viscosity of not greater than about 1000 centipoise.

In one aspect, the invention is to a substrate suitable for receiving an ink jetted ink, the substrate comprising: (a) a support material having a surface; and (b) a primary reducing agent disposed over at least a portion of the surface.

### DETAILED DESCRIPTION OF THE INVENTION

I. Introduction

In one aspect, the present invention provides processes for forming conductive features from one or more inks. In one embodiment, the invention is to a process that includes a step of applying a first ink comprising a metal precursor to at least a portion of a first substrate to form an at least partially coated substrate. In a second step, the first ink is contacted with a primary reducing agent under conditions effective to reduce the metal in the metal precursor to its elemental form.

In another aspect, the invention is directed to conductive features that may be formed according to the processes of the present invention. The conductive features of the present invention may form all or a portion of a capacitor, a resistor or of an active component such as a transistor.

In another embodiment, the invention is to a reducing agent composition suitable for ink jetting.

In yet another aspect, the invention is to a substrate having a primary reducing agent disposed thereon, the substrate being suitable for receiving an ink jetted ink to form an electronic feature.

II. Processes for Forming Conductive Features

As indicated above, in one embodiment, the present invention is directed to a process for forming a conductive feature, the process comprising the steps of: (a) applying a first ink comprising a metal precursor to at least a portion of a first substrate to form an at least partially coated substrate; and (b) contacting the first ink with a primary reducing agent under conditions effective to reduce the metal in the metal precursor to its elemental form.

A. The First Ink

As used herein, the term “first ink” means an ink composition comprising a metal precursor. When used to modify the term “ink,” the numerical terms “first,” “second,” etc. are used to distinguish the respective inks from one another and are not intended to convey any particular order in which the inks must be applied. Thus, a second ink may be applied to a substrate before, after or simultaneously with the application of a first ink.

The first ink optionally contains one or more components in addition to the metal precursor. A non-limiting list of exemplary components that may be included in the first ink includes: a liquid vehicle (e.g., a solvent or carrier liquid), secondary reducing agents, particulates (e.g., metal nanoparticles, alloy nanoparticles, carbon nanoparticles and/or metal oxide nanoparticles), conductive polymers and/or other additives. It is contemplated that the first ink may comprise one or more components that provide multiple functions. For example, it is contemplated that an additive, e.g., crystallization inhibitor, polymer, binder, dispersant, surfactant, humectant, etc., in the first ink may be in liquid form and also act as the liquid vehicle or as a portion of the liquid vehicle.

1. Metal Precursors

As used herein, the term “metal precursor” means a compound comprising a metal and capable of being converted (e.g., through a reaction with a reducing agent optionally with the application of heat) to form an elemental metal corresponding to the metal in the metal precursor. “Elemental metal” means a substantially pure metal or alloy having an oxidation state of 0. Examples of metal precursors include organometallics (molecules with carbon-metal bonds), metal organics (molecules containing organic ligands with metal bonds to other types of elements such as oxygen, nitrogen or sulfur) and inorganic compounds such as metal nitrates, metal halides and other metal salts.

It is contemplated that not all of the metal in the metal precursor contained in the first ink may be converted to elemental form during the contacting step. Preferably, at least about 50 weight percent, at least about 75 weight percent and most preferably at least about 95 weight percent of the metal in the metal precursor contained in the first ink is converted to elemental form.

In a preferred embodiment, the metal in the metal precursor comprises one or more of silver (Ag), nickel (Ni), platinum (Pt), gold (Au), palladium (Pd), copper (Cu), ruthenium (Ru), indium (In) or tin (Sn), with silver being preferred for its high conductivity and copper being preferred for its good conductivity and low cost. In alternative embodiments, the metal in the metal precursor can include one or more of aluminum (Al), zinc (Zn), iron (Fe), tungsten (W), molybdenum (Mo), lead (Pb), bismuth (Bi), cobalt (Co) or similar metals. In a preferred embodiment, the metal precursor is soluble in one or more solvents in the first ink, although it is contemplated that the metal precursor may be insoluble in the first ink.

In another aspect, the metal precursor comprises a metal oxide, e.g., Ag₂O. In this embodiment, the first ink optionally is in the form a colloidal composition rather than a solution, the metal oxide being carried by a carrier medium. Such colloidal compositions may be well-suited for direct write printing applications. When the metal oxide contacts the primary reducing agent, the metal in the metal oxide is reduced to form the corresponding elemental metal.

In general, metal precursors that eliminate one or more ligands by a radical mechanism upon conversion to the elemental metal are preferred, especially if the intermediate species formed are stable radicals and therefore lower the decomposition temperature of that precursor compound.

In one aspect, metal precursors comprising ligands that eliminate cleanly upon conversion and escape completely from the substrate (or the formed functional structure) are preferred because they are not susceptible to carbon contamination or contamination by anionic species such as nitrates. Therefore, preferred metal precursors for metals used for conductors are carboxylates, alkoxides or combinations thereof that would convert to metals, metal oxides or mixed metal oxides by eliminating small molecules such as carboxylic acid anhydrides, ethers or esters. Metal carboxylates, particularly halogenocarboxylates such as fluorocarboxylates, are particularly preferred metal precursors due to their high solubility.

In several preferred aspects of the invention, the metal precursor comprises a metal nitrate (e.g., silver nitrate, copper nitrate or nickel nitrate) or a metal carboxylate (e.g., silver carboxylate, copper carboxylate or nickel carboxylate).

Examples of silver-precursors useful as the metal precursor of the present invention are included in Table 1.

TABLE 1
SILVER PRECURSORS

| General Class | Examples | Chemical Formula |
|---|---|---|
| Nitrates | Silver nitrate | AgNO₃ |
| Nitrites | Silver nitrite | AgNO₂ |
| Oxides | Silver oxide | Ag₂O, AgO |
| Carbonates | Silver carbonate | Ag₂CO₃ |
| Oxalates | Silver oxalate | Ag₂C₂O₄ |
| (Pyrazolyl) | Silver trispyrazolylborate | Ag[(N₂C₃H₃)₃]BH |
| borates | | |
| | Silver | Ag[((CH₃)₂N₂C₃H₃)₃]BH |
| | tris(dimethylpyrazolyl)borate | |
| Azides | Silver azide | AgN₃ |
| Fluoroborates | Silver tetrafluoroborate | AgBF₄ |
| Carboxylates | Silver acetate | AgO₂CCH₃ |
| | Silver propionate | AgO₂CC₂H₅ |
| | Silver butanoate | AgO₂CC₃H₇ |
| | Silver ethylbutyrate | AgO₂CCH(C₂H₅)C₂H₅ |
| | Silver pivalate | AgO₂CC(CH₃)₃ |
| | Silver cyclohexanebutyrate | AgO₂C(CH₂)₃C₆H₁₁ |
| | Silver ethlyhexanoate | AgO₂CCH(C₂H₅)C₄H₉ |
| | Silver neodecanoate | AgO₂CC₉H₁₉ |
| Halogencarboxylates | Silver trifluoroacetate | AgO₂CCF₃ |
| | Silver pentafluoropropionate | AgO₂CC₂F₅ |
| | Silver heptafluorobutyrate | AgO₂CC₃F₇ |
| | Silver trichloroacetate | AgO₂CCCI₃ |
| | Silver 6,6,7,7,8,8,8- | AgFOD |
| | heptafluoro-2,2-dimethyl- | |
| | 3,5-octanedionate | |
| Hydroxycarboxylates | Silver lactate | AgO₂CH(OH)CH₃ |
| | Silver citrate | Ag₃C₆H₅O₇ |
| | Silver glycolate | AgOOCCH(OH)CH₃ |
| Aminocarboxylates | Silver glyconate | |
| Aromatic and | Silver benzoate | AgO₂CCH₂C₆H₅ |
| nitro and/or | Silver phenylacetate | AgOOCCH₂C₆H₅ |
| fluoro | Silver nitrophenylacetates | AgOOCCH₂C₆H₄NO₂ |
| substituted | Silver dinitrophenylacetate | AgOOCCH₂C₆H₃(NO₂)₂ |
| aromatic | Silver difluorophenylacetate | AgOOCCH₂C₆H₃F₂ |
| Carboxylates | Silver 2-fluoro-5- | AgOOCC₆H₃(NO₂)F |
| | nitrobenzoate | |
| Beta diketonates | Silver acetylacetonate | Ag[CH₃COCH═C(O—)CH₃] |
| | Silver | Ag[CF₃COCH═C(O—)CF₃] |
| | hexafluoroacetylacetonate | |
| | Silver | Ag[CH₃COCH═C(O—)CF₃] |
| | trifluoroacetylacetonate | |
| Silver sulfonates | Silver tosylate | AgO₃SC₆H₄CH₃ |
| | Silver triflate | AgO₃SCF₃ |

In addition to the foregoing, complex silver salts containing neutral inorganic or organic ligands can also be used as the metal precursor. These salts are usually in the form of nitrates, halides, perchlorates, hydroxides or tetrafluoroborates. Examples are listed in Table 2.

TABLE 2
COMPLEX SILVER SALTS

| Class | Examples (Cation) |
|---|---|
| Amines | [Ag(RNH₂)₂]⁺, [Ag(R₂NH)₂]⁺, [Ag(R₃N)₂]⁺, |
| | R = aliphatic or aromatic |
| N-Heterocycles | [Ag(L)ₓ]⁺, (L = aziridine, pyrrol, indol, piperidine, |
| | pyridine, aliphatic substituted and amino |
| | substituted pyridines, imidazole, pyrimidine, |
| | piperazine, triazoles, etc.) |
| Amino alcohols | [Ag(L)ₓ]⁺, L = Ethanolamine |
| Amino acids | [Ag(L)ₓ]⁺, L = Glycine |
| Acid amides | [Ag(L)ₓ]⁺, L = Formamides, acetamides |
| Nitriles | [Ag(L)ₓ]⁺, L = Acetonitriles |
| Surfactant Salts | Ag[AOT]⁻ |

Preferred metal precursors for silver in organic solvents include Ag-nitrate, Ag-neodecanoate, Ag-trifluoroacetate, Ag-acetate, Ag-lactate, Ag-cyclohexanebutyrate, Ag-carbonate, Ag-oxide, Ag-ethylhexanoate, Ag-acetylacetonate, Ag-ethylbutyrate, Ag-pentafluoropropionate, Ag-benzoate, Ag-citrate, Ag-heptafluorobutyrate, Ag-salicylate, Ag-decanoate and Ag-glycolate. Among the foregoing, particularly preferred metal precursors for silver include Ag-acetate, Ag-nitrate, Ag-trifluoroacetate and Ag-neodecanoate. Most preferred among the foregoing silver precursors are Ag-trifluoroacetate and Ag-acetate. The preferred precursors generally have a high solubility and high metal yield, and are available at a relatively low cost. For example, Ag-trifluoroacetate has a solubility in dimethylacetamide (DMAc) of about 78 wt. % and Ag-trifluoroacetate is a particularly preferred silver precursor.

Preferred silver precursors for aqueous-based solvents include Ag-nitrates, Ag-fluorides such as silver fluoride or silver hydrogen fluoride (AgHF₂), Ag-thiosulfate, Ag-trifluoroacetate and soluble diammine complexes of silver salts.

Silver precursors in solid form (optionally as a colloidal composition, as discussed above) that decompose at a low temperature, such as not greater than about 200° C., can also be used as a metal precursor. Examples include Ag-oxide, Ag-nitrite, Ag-carbonate, Ag-lactate, Ag-sulfite, Ag-oxalate and Ag-citrate.

When a more volatile silver precursor is desired, such as for spray deposition of the first ink, the precursor can be selected from alkene silver betadiketonates, R₂(CH)₂Ag[R′COCH═C(O—)CR″] where R=methyl or ethyl and R′, R″=CF₃, C₂F₅, C₃F₇, CH₃, CₘH₂ₘ₊₁ (m=2 to 4), or trialkylphosphine and triarylphosphine derivatives of silver carboxylates, silver beta diketonates or silver cyclopentadienides.

A non-limiting list of metal precursors for nickel is presented in Table 3. A particularly preferred nickel precursor for use with an aqueous-based solvent is Ni-acetylacetonate.

TABLE 3
NICKEL PRECURSORS

| General Class | Example | Chemical Formula |
|---|---|---|
| Inorganic Salts | Ni-nitrate | Ni(NO₃)₂ |
| | Ni-sulfate | NiSO₄ |
| | Nickel ammine complexes | [Ni(NH₃)₆]ⁿ⁺ (n = 2, 3) |
| | Ni-tetrafluoroborate | Ni(BF₄)₂ |
| Metal Organics | Ni-oxalate | NiC₂O₄ |
| (Alkoxides, | Ni-isopropoxide | Ni(OC₃H₇)₂ |
| Beta- | Ni-methoxyethoxide | Ni(OCH₂CH₂OCH₃)₂ |
| diketonates, | Ni-acetylacetonate | Ni(CH₃COCH═C(O—)CH₃)₂ |
| Carboxylates, | | or Ni(CH₃COCH═C(O—)CH₃)₂(H₂O)₂ |
| and | Ni-hexafluoroacetylacetonate | Ni[CF₃COCH═C(O—)CF₃]₂ |
| Fluorocarboxylates) | Ni-formate | Ni(O₂CH)₂ |
| | Ni-acetate | Ni(O₂CCH₃)₂ |
| | Ni-octanoate | Ni(O₂CC₇H₁₅)₂ |
| | Ni-ethylhexanoate | Ni(O₂CCH(C₂H₅)C₄H₉)₂ |
| | Ni-trifluoroacetate | Ni(OOCCF₃)₂ |

Various metal precursors can be used for platinum metal. Preferred metal precursors include ammonium salts of platinates such as ammonium hexachloro platinate (NH₄)₂PtCl₆, and ammonium tetrachloro platinate (NH₄)₂PtCl₄; sodium and potassium salts of halogeno, pseudohalogeno or nitrito platinates such as potassium hexachloro platinate K₂PtCl₆, sodium tetrachloro platinate Na₂PtCl₄, potassium hexabromo platinate K₂PtBr₆, potassium tetranitrito platinate K₂Pt(NO₂)₄; dihydrogen salts of hydroxo or halogeno platinates such as hexachloro platinic acid H₂PtCl₆, hexabromo platinic acid H₂PtBr₆, dihydrogen hexahydroxo platinate H₂Pt(OH)₆; diammine, diammine platinum chloride Pt(NH₃)₂Cl₂, and tetraammine platinum compounds such as tetraammine platinum chloride [Pt(NH₃)₄]Cl₂, tetraammine platinum hydroxide [Pt(NH₃)₄](OH)₂, tetraammine platinum nitrite [Pt(NH₃)₄](NO₂)₂, tetrammine platinum nitrate [Pt(NH₃)₄](NO₃)₂, tetrammine platinum bicarbonate [Pt(NH₃)₄](HCO₃)₂, tetraammine platinum tetrachloroplatinate [Pt(NH₃)₄]PtCl₄; platinum diketonates such as platinum (II) 2,4-pentanedionate Pt(C₅H₇O₂)₂; platinum nitrates such as dihydrogen hexahydroxo platinate H₂Pt(OH)₆ acidified with nitric acid; other platinum salts such as Pt-sulfite and Pt-oxalate; and platinum salts comprising other N-donor ligands such as [Pt(CN)₆]⁴⁺.

Platinum precursors useful in organic-based first ink formulations include Pt-carboxylates or mixed carboxylates. Examples of carboxylates include Pt-formate, Pt-acetate, Pt-propionate, Pt-benzoate, Pt-stearate, Pt-neodecanoate. Other precursors useful in organic vehicles include aminoorgano platinum compounds including Pt(diaminopropane) (ethylhexanoate).

Preferred combinations of platinum precursors and solvents include: PtCl₄ in H₂O; Pt-nitrate solution from H₂Pt(OH)₆; H₂Pt(OH)₆ in H₂O; H₂PtCl₆ in H₂O; and [Pt(NH₃)₄](NO₃)₂ in H₂O.

Gold precursors that are particularly useful for aqueous based precursor compositions include Au-chloride (AuCl₃) and tetrachloric auric acid (HAuCl₄).

Gold precursors useful for organic based formulations include: Au-thiolates, Au-carboxylates such as Au-acetate Au(O₂CCH₃)₃; aminoorgano gold carboxylates such as imidazole gold ethylhexanoate; mixed gold carboxylates such as gold hydroxide acetate isobutyrate; Au-thiocarboxylates and Au-dithiocarboxylates.

In general, preferred gold metal precursors for low temperature conversion are compounds comprising a set of different ligands such as mixed carboxylates or mixed alkoxo metal carboxylates. As one example, gold acetate isobutyrate hydroxide decomposes at 155° C., a lower temperature than gold acetate. As another example, gold acetate neodecanoate hydroxide decomposes to gold metal at even lower temperature, 125° C. Still other examples can be selected from gold acetate trifluoroacetate hydroxide, gold bis(trifluoroacetate) hydroxide and gold acetate pivalate hydroxide.

Other useful gold precursors include Au-azide and Au-isocyanide. When a more volatile molecular gold precursor is desired, such as for spray deposition, the precursor can be selected from:
dialkyl and monoalkyl gold carboxylates, R₃₋ₙAu(O₂CR′)ₙ; (n=1,2); R=methyl, ethyl; R′=CF₃, C₂F₅, C₃F₇, CH₃, CₘH₂ₘ₊₁ (m=2-9)
dialkyl and monoalkyl gold beta diketonates, R₃₋ₙAu [R′COCH═C(O—)CR″]ₙ; (n=1,2); R=methyl, ethyl; R′, R″=CF₃, C₂F₅, C₃F₇, CH₃, CₘH₂ₘ₊₁ (m=2-4)
dialkyl and monoalkyl gold alkoxides, R₃₋ₙAu(OR′)ₙ; (n=1,2); R=methyl, ethyl; R′=CF₃, C₂F₅, C₃F₇, CH₃, CₘH₂ₘ₊₁ (m=2-4), SiR₃″ (R″=methyl, ethyl, propyl, isopropyl, n-butyl, isobutyl, tert-butyl)

Phosphine gold complexes, such as:
RAu(PR′₃); R, R′=methyl, ethyl, propyl, isopropyl, n-butyl, isobutyl, tert-butyl
R₃Au(PR′₃); R, R′=methyl, ethyl, propyl, isopropyl, n-butyl, isobutyl, tert.butyl.

Particularly useful metal precursors to palladium for organic based precursor compositions according to several aspects of the present invention include Pd-carboxylates, including Pd-fluorocarboxylates such as Pd-acetate, Pd-propionate, Pd-ethylhexanoate, Pd-neodecanoate and Pd-trifluoroacetate as well as mixed carboxylates such as Pd(OOCH)(OAc), Pd(OAc)(ethylhexanoate), Pd(ethylhexanoate)₂, Pd(OOCH)_{1.5}(ethylhexanoate)_{0.5}, Pd(OOCH)(ethylhexanoate), Pd(OOCCH(OH)CH(OH)COOH)m (ethylhexanoate), Pd(OPr)₂, Pd(OAc)(OPr), Pd-oxalate, Pd(OOCCHO)ₘ(OOCCH₂OH)ₙ=(Glyoxilic palladium glycolate) and Pd-alkoxides. A particularly preferred palladium precursor is Pd-trifluoroacetate.

Palladium precursors useful for aqueous based precursor compositions include: tetraammine palladium hydroxide [Pd(NH₃)₄](OH)₂; Pd-nitrate Pd(NO₃)₂; Pd-oxalate Pd(O₂CCO₂)₂; Pd-chloride PdCl₂; Di- and tetraammine palladium chlorides, hydroxides or nitrates such as tetraammine palladium chloride [Pd(NH₃)₄]Cl₂, tetraammine palladium hydroxide [Pd(NH₃)₄](OH)₂, tetraammine palladium nitrate [Pd(NH₃)₄](NO₃)₂, diammine palladium nitrate [Pd(NH₃)₂](NO₃)₂ and tetraammine palladium tetrachloropalladate [Pd(NH₃)₄][PdCl₄].

When selecting a copper precursor, it is desired that the compound react during processing to elemental copper without the formation of copper oxide or other species that are detrimental to the conductivity of the resulting conductive copper feature. The copper precursors derived from the first ink optionally require a reducing agent optionally derived from the second ink to be converted to copper metal at the desired conditions, although the copper precursor may be used in combination with a secondary copper precursor that may be thermally converted to elemental copper. As is discussed in more detail below, reducing agents are materials that are oxidized, thereby causing the reduction of another substance. The reducing agent loses one or more electrons and is referred to as having been oxidized. The introduction of the reducing agent can occur in the form of a chemical agent (e.g., formic acid) that is soluble in the first ink to afford a reduction to copper either during transport to the substrate or on the substrate. In some cases, the ligand of the molecular copper precursor has reducing characteristics, such as in Cu-formate or Cu-hypophosphite, leading to reduction to copper metal. However, formation of metallic copper or other undesired side reactions that occur prematurely in the ink should typically be avoided.

Accordingly, the ligand can be an important factor in the selection of suitable copper metal precursors. During thermal decomposition or reduction of the precursor, the ligand needs to leave the system cleanly, preferably without the formation of carbon or other residues that could be incorporated into the copper feature. Copper precursors containing inorganic ligands are preferred in cases where carbon contamination is detrimental. Other desired characteristics for molecular copper precursors are low decomposition temperature or processing temperature for reduction to copper metal, high solubility in the selected solvent/vehicle to increase metallic yield and form dense features and the compound should be environmentally benign.

Preferred copper metal precursors include Cu-formate and Cu-neodecanoate. Copper precursors that are useful for aqueous-based inks include: Cu-nitrate and ammine complexes thereof; Cu-carboxylates including Cu-formate and Cu-acetate; and Cu beta-diketonates such as Cu-hexafluoroacetylacetonate and copper salts such as Cu-chloride.

Copper precursors generally useful for organic based formulations include: Cu-carboxylates and Cu-fluorocarboxylates, such as Cu-formate; Cu-ethylhexanoate; Cu-neodecanoate; Cu-methacrylate; Cu-trifluoroacetate; Cu-hexanoate; and copper beta-diketonates such as cyclooctadiene Cu hexafluoroacetylacetonate.

Among the foregoing, Cu-formate is particularly preferred as it is highly soluble in water and results in the in-situ formation of formic acid, which is an effective reducing agent.

Copper precursors that are useful can also be categorized as copper I and copper II compounds. They can be categorized as inorganic, metal organic, and organometallic. They can also be categorized as copper hydrides, copper amides, copper alkenes, copper allyls, copper carbonyls, copper metallocenes, copper cyclopentadienyls, copper arenes, copper carbonates, copper hydroxides, copper carboxylates, copper oxides, organo copper, copper beta-diketonates, copper alkoxides, copper beta-ketoiminates, copper halides, copper alkyls. The copper compounds can have neutral donor ligands or not have neutral ligands. Copper I compounds are particularly useful for disproportionation reactions. The disproportionation products are copper metal and a copper II compound. In some cases a neutral ligand is also a product.

In a novel approach, the copper II product can be rapidly converted back to a copper I compound using a reducing agent. Appropriate reducing agents for reducing copper II to copper I are known in the art. Useful reducing agents for copper precursors include ethylene diamine, tetramethylethylenediamine, 3 aminopropanol, mono, di and triethanolamine. Useful reducing agents are described in U.S. Pat. No. 5,378,508, which is incorporated herein by reference in its entirety. The resulting copper I compound reacts further via disproportionation to form more copper and copper II compound. Through this approach with excess reducing agent, copper I compounds can be used to form pure copper metal without any copper II compounds.

The copper compounds can also be used as capping agents to cap copper particles. U.S. Pat. No. 6,294,401 by Jacobsen describes such capping procedures and is incorporated herein by reference in its entirety.

As discussed above, two or more metal precursors can be combined in the ink composition(s) to form metal alloys and/or metal compounds. For example, preferred combinations of metal precursors to form alloys based on silver include: Ag-nitrate and Pd-nitrate; Ag-acetate and [Pd(NH₃)₄](OH)₂; Ag-trifluoroacetate and [Pd(NH₃)₄](OH)₂; and Ag-neodecanoate and Pd-neodecanoate. One particularly preferred combination of metal precursors is Ag-trifluoroacetate and Pd-trifluoroacetate. Another preferred alloy is Ag/Cu.

To form alloys, the two (or more) metal precursors should have similar decomposition temperatures to avoid the formation of one of the metal species before the other species. Preferably, the decomposition temperatures of the different metal precursors are within 50° C., more preferably within 25° C.

Some applications require the utilization of a transparent or semi-transparent conductive feature. For example, indium tin oxide (ITO) is useful for the formation of transparent conductive features, such as for use in display applications. Antimony tin oxide (ATO) is useful as a color tunable oxide layer that finds use in electrochromic applications. Other metal oxides that are useful include zinc aluminum oxide, gallium aluminum zinc oxide, zinc oxide, and vanadium oxides.

Such transparent conductive features can also be fabricated according to one aspect of the present invention. For ITO, useful metal precursors for indium include: In-nitrate; In-chloride; In-carboxylates such as In-acetate; In-propionates including fluoro, chloro or bromo derivatives thereof; beta diketonates such as In-acetylacetonate, In-hexafluoroacetylacetonate and In-trifluoroacetylacetonate; pyrazolyl borohydrides such as In(pz)₃BH; In-alkoxides and In-fluoroalkoxides; and In-amides. Mixed alkoxo In-carboxylates such as indium isopropoxide ethylhexanoate are also useful.

Useful metal precursors for tin in ITO or ATO include: Sn-halides such as Sn-tetrachloride; Sn-dichloride; Sn-carboxylates such as Sn-acetate or Sn-ethylhexanoate; Sn-alkoxides such as Sn(OtBu)₄; Sn-hydroxycarboxylates such as Sn-glycolate; and beta diketonates such as Sn-hexafluoroacetylacetonate.

Useful metal precursors for antimony include: Sb-trichloride; antimony carboxylates such as Sb-acetate or Sb-neodecanoate; antimony alkoxides such as Sb-methoxide, Sb-ethoxide, Sb-butoxide.

The amount of metal precursor in the first ink may vary widely depending, for example, on the type of desired application process, the relative amount of metal in the entire metal precursor and other factors. In various embodiments, the first ink optionally comprises the metal in the metal precursor in an amount greater than about 1 weight percent, e.g., greater than about 5 weight percent or greater than about 10 weight percent, based on the total weight of the first ink. In terms of upper range limits, the first ink optionally comprises the metal in the metal precursor in an amount less than about 75 weight percent, e.g., less than about 50 weight percent or less than about 30 weight percent, based on the total weight of the first ink. In terms of ranges, the first ink optionally comprises the metal in the metal precursor in an amount from about 1 to about 50 weight percent, e.g., from about 5 to about 30 or from about 10 to about 20 weight percent, based on the total weight of the first ink.

2. Liquid Vehicles

Typically, the first ink comprises a “liquid vehicle,” which is defined herein as a flowable medium that facilitates deposition of the first ink, such as by imparting sufficient flow properties or supporting dispersed particles. The liquid vehicle may act as a solvent to one or more components contained in the first ink and/or as a carrier to one or more particulates, e.g., as an emulsion, or a solvent. In a preferred embodiment, the liquid vehicle comprises a solvent in which the metal precursor is dissolved. The liquid vehicle optionally includes one or more additives.

The metal precursor can be utilized in an aqueous-based solvent, an organic solvent or a combination thereof. Aqueous liquids may be preferred for use as the liquid vehicle in many situations because of their low cost, relative safety and ease of use. For example, water has the advantage of being non-flammable, and when vaporized during the formation of the particles does not tend to contribute to formation of byproducts that are likely to complicate processing or contaminate the ultimately resulting conductive features. Moreover, aqueous liquids are good solvents for a large number of metal precursors, although attaining a desired level of solubility for some materials may involve modification of the aqueous liquid, such as pH adjustment.

Aqueous solvents, however, cannot easily be used for depositing an ink onto hydrophobic substrates, such as tetrafluoroethylene fluorocarbon substrates (e.g., TEFLON, E.I. duPont deNemours, Wilmington, Del.) without modification of the substrate or the aqueous composition. Thus, in some situations, organic liquids or solvents may be used for the liquid vehicle. For example, organic solvents may be preferred in situations when the metal precursor (e.g., an organometallic metal precursor) is not adequately soluble in aqueous liquids, or when aqueous liquids are otherwise detrimental to the precursor.

The liquid vehicle can also include an organic solvent, by itself or in addition to water. The selected solvent should be capable of solubilizing the selected metal precursor to a high level. A low solubility of the metal precursor in the solvent leads to low yields of the conductor, thin deposits and low conductivity. The first ink of the present invention exploits combinations of solvents and metal precursors that advantageously provide high solubility of the metal precursor while still allowing low temperature conversion of the precursor to the conductor.

The liquid vehicle (e.g., solvent and/or carrier composition) can be polar or non-polar. Solvents that are useful include amines, amides, alcohols, water, ketones, unsaturated hydrocarbons, saturated hydrocarbons, mineral acids organic acids and bases. Preferred solvents include alcohols, amines, amides, water, ketones, ethers, aldehydes, alkenes, and hydrocarbons. Although some reactivity of the liquid vehicle with the metal precursor may be tolerated, it is important that the liquid vehicle be less capable than the primary reducing agent at reducing the metal in the metal precursor to its elemental form. Particularly preferred organic solvents include N,N,-dimethylacetamide (DMAc), diethyleneglycol butylether (DEGBE), ethanolamine and N-methyl pyrrolidone.

In some cases, the liquid vehicle can be a high melting point liquid vehicle, such as one having a melting point of at least about 30° C. and not greater than about 100° C. In this embodiment, a heated ink-jet head can be used to deposit the first ink while in a flowable state whereby the liquid vehicle solidifies upon contacting the substrate. Subsequent processing can then remove the liquid vehicle by other means and then convert the material to the final product, thereby retaining resolution. Preferred liquid vehicles according to this embodiment are waxes, high molecular weight fatty acids, alcohols, acetone, N-methyl-2-pyrrolidone, toluene, tetrahydrofuran and the like. Alternatively, the ink may be a liquid at room temperature, wherein the substrate is kept at a lower temperature below the freezing point of the composition.

The liquid vehicle can also be a low melting point liquid vehicle. A low melting point is required when the precursor composition must remain as a liquid on the substrate until dried. A preferred low melting point liquid vehicle according to this embodiment is DMAc, which has a melting point of about −20° C.

In addition, the liquid vehicle can be a low vapor pressure solvent. A lower vapor pressure advantageously prolongs the work life of the composition in cases where evaporation in the ink-jet head, syringe or other tool leads to problems such as clogging. A preferred liquid vehicle according to this embodiment is terpineol. Other low vapor pressure liquid vehicles include diethylene glycol, ethylene glycol, hexylene glycol, N-methyl-2-pyrrolidone, glycerol, 2-pyrolidone, polyethylene glycols, and tri(ethylene glycol) dimethyl ether.

The liquid vehicle can also be a high vapor pressure solvent, such as one having a vapor pressure of at least about 1 kPa. A high vapor pressure allows rapid removal of the solvent by drying. High vapor pressure liquid vehicles include acetone, tetrahydrofuran, toluene, xylene, ethanol, methanol, 2-butanone and water.

The amount of liquid vehicle in the first ink may vary depending, for example, on the solubility of the metal precursor in the liquid vehicle or the presence of multiple liquid vehicles. In other embodiments, the amount of vehicle in the first ink may vary depending, for example, on the size of the particles in the ink, if any, and on the desired viscosity of the first ink. As non-limiting examples, the first ink optionally comprises the liquid vehicle (e.g., solvent and/or carrier medium) in an amount from about 20 to about 99 weight percent, e.g., from about 30 to about 95 weight percent or from about 40 to about 70 weight percent, based on the total weight of the first ink.

Examples of ink-jet liquid vehicle compositions are disclosed in U.S. Pat. No. 5,853,470 by Martin et al.; U.S. Pat. No. 5,679,724 by Sacripante et al.; U.S. Pat. No. 5,725,647 by Carlson et al.; U.S. Pat. No. 4,877,451 by Winnik et al.; U.S. Pat. No. 5,837,045 by Johnson et al.; and U.S. Pat. No. 5,837,041 by Bean et al. Each of the foregoing U.S. patents is incorporated by reference herein in their entirety. Examples of preferred vehicles are listed in Table 4. Particularly preferred vehicles include alpha terpineol, toluene and ethylene glycol.

TABLE 4
LIQUID VEHICLES

| FORMULA/CLASS | NAME |
|---|---|
| Alcohols | 2-octanol |
| | Benzyl alcohol |
| | 4-hydroxy-3-methoxy |
| | benzaldehyde |
| | Isodeconol |
| | Butylcarbitol |
| Turpene alcohol | Alpha terpineol |
| | Beta terpineol |
| | Cineol |
| Esters | 2,2,4-trimethylpentanediol-1,3- |
| | monoisobutyrate |
| | Butyl carbitol acetate |
| | Butyl oxalate |
| | Dibutyl phthalate |
| | Dibutyl benzoate |
| | Butyl cellosolve acetate |
| | Ethylene glycol diacetate |
| | N-methyl-2-pyrolidone |
| Amides | N,N-dimethyl formamide |
| | N,N-dimethyl acetamide |
| Aromatics | Xylenes |
| | Aromasol |
| Substituted aromatics | Nitrobenzene |
| | o-nitrotoluene |
| Terpenes | Alpha-pinene, beta-pinene |
| | dipentene dipentene oxide |
| Essential oils | Rosemary, lavender, fennel, |
| | sassafras, wintergreen, anise oils, |
| | camphor, turpentine |

3. Secondary Reducing Agents

In one embodiment of the present invention, the first ink further comprises a secondary reducing agent. As used herein, the term “secondary reducing agent” means a reducing agent (other than the primary reducing agent, discussed below) included in the first ink. The modifier “secondary” in this term is intended to distinguish the reducing agent that may be present in the first ink (the secondary reducing agent) from the primary reducing agent, discussed in more detail below, which is typically derived from a source other than the first ink. The primary reducing agent, for example, optionally is derived from a second ink, from a preformed substrate or from a carrying gas. Although the first ink preferably does not comprise any primary reducing agent, it is contemplated that the first ink may comprise a very minor amount of primary reducing agent relative to the amount of primary reducing agent provided by the source other than the first ink, e.g., the second ink, the substrate or the carrying gas.

The secondary reducing agent may be selected from one or more compounds that are capable of being oxidized and hence that are capable of reducing the metal precursor to its corresponding elemental metal. In general, the secondary reducing agent may be selected from any of the primary reducing agents, discussed in detail below. In a preferred embodiment, however, the secondary reducing agent is less reactive than the primary reducing agent in reacting with the metal precursor to form the elemental metal.

Additionally or alternatively, the secondary reducing agent can also be part of the metal precursor, for example in the case of certain ligands. An example is Cu-formate, where the precursor forms copper metal even in ambient air at low temperatures. In addition, the Cu-formate precursor is highly soluble in water, results in a relatively high metallic yield and forms only gaseous byproducts, which are reducing in nature and protect the in-situ formed copper from oxidation. Cu-formate is therefore a preferred copper precursor for aqueous based inks. Other examples of molecular metal precursors containing a ligand that is a reducing agent are Ni-acetylacetonate and Ni-formate.

If present in the first ink, the first ink optionally comprises the secondary reducing agent in an amount from about 1 to about 50 weight percent, e.g., from about 5 to about 40 weight percent or from about 20 to about 30 weight percent, based on the total weight of the first ink.

4. Particulate Materials

The first ink also optionally includes particulate material, e.g., metal particles. In one embodiment, the particles comprise microparticles, defined herein as particles having an average particle size (d50 value) of not greater than about 10 microns, not greater than 5 microns, not greater than 2 microns, or not greater than 1 micron. The particles preferably comprise nanoparticles, which have an average particle size of not greater than about 500 nanometers, preferably not greater than about 100 nanometers. In terms of ranges, the nanoparticles preferably have an average particle size of from about 10 to 80 nanometers, e.g., from about 25 to 75 nanometers, and are not substantially agglomerated.

In one embodiment, the solids loading of particles in the first ink is as high as possible without adversely affecting the viscosity or other necessary properties of the composition. For example, the first ink optionally has a particle loading of up to about 75 volume percent. If included in the first ink, the first ink preferably comprises at least about 1 volume percent or at least about 5 volume percent particulates, preferably metal nanoparticles. In various other embodiments, the first ink optionally comprises at least about 10 volume percent or at least about 15 volume percent particulates. In terms of ranges, the first ink optionally comprises from about 1 to about 60 volume percent particulates (preferably metal nanoparticles), e.g., from about 10 to about 60 volume percent, or from about 30 to about 40 volume percent particulates, based on the total weight of the first ink. In another embodiment, the first ink optionally comprises from about 5 volume percent to about 30 volume percent particulates (e.g., metal nanoparticles). Preferably, the particle loading does not exceed about 40 volume percent particularly where adequate flow properties must be maintained for the first ink.

If the first ink comprises metal nanoparticles, then the weight ratio of the metal in the metal precursor to the metal in the metal nanoparticles optionally is from about 0.2 to about 1.0.

In one aspect, the particles are spheroidal, meaning that they are generally of spherical shape, even if not perfectly spherical. Optionally, a majority of the particles have a morphology that is spherical, hollow, rod, flake, platelet, wired, fibrous, cubed or trigonal.

In another aspect, the particles comprise nanorods. The nanorods optionally have an average diameter of less than about 100 nm, e.g., less than about 50 nm or less than about 20 nm. The nanorods optionally have an average length of at least about 10 microns, e.g., at least about 50 microns. The nanorods optionally are formed of conducting materials such as metals and/or semiconductors.

In a preferred embodiment, the particles comprise one or more metals, metal oxides, main group elements, metal mixtures or alloy materials or mixtures or combinations of these materials. Examples of inorganic materials for possible inclusion in the particles include metallic materials, (including single metals, alloys and intermetallic compounds), ceramics, main group elements, such as Si, Ge and mixed main group materials or mixed metal/main group materials, such as CdSe, GaAs, and InP.

While particles of any metal (or non-metal) can be used in accordance with this aspect of the invention, it is preferred to use metals that have a low cost and/or a high conductivity. Particularly preferred nanoparticle compositions for the present invention include silver (Ag), nickel (Ni), platinum (Pt), gold (Au), palladium (Pd), copper (Cu), ruthenium (Ru), indium (In) or tin (Sn), with silver being preferred for its high conductivity and copper being preferred for its good conductivity and low cost. In alternative embodiments, the metal in the particles can include one or more of aluminum (Al), zinc (Zn), iron (Fe), tungsten (W), molybdenum (Mo), lead (Pb), bismuth (Bi) or similar metals. In addition, some metal oxides can be useful such as ZnO, Al₂O₃, CuOₓ, SiO₂ and TiO₂, conductive metal oxides such as In₂O₃, indium-tin oxide (ITO), antimony-tin oxide (ATO), zinc-aluminum-oxide, and gallium zinc aluminum oxide. Other useful nanoparticles of metal oxides include pyrogenous silica such as HS-5 or M5 or others (Cabot Corp., Boston, Mass.) and Aerosil 200 or others (Degussa AG, Dusseldorf, Germany) or surface modified silica such as TS530 or TS720 (Cabot Corp., Boston, Mass.) and Aerosil 380 (Degussa AG, Dusseldorf, Germany). In one embodiment of the present invention, the nanoparticles include the same metal that is contained in the metal precursor compound, discussed above. Nanoparticles can be fabricated using a number of methods and one preferred method, referred to as the Polyol process, is disclosed in U.S. Pat. No. 4,539,041 by Figlarz et al., which is incorporated herein by reference in its entirety. See also U.S. Provisional Patent Application Ser. Nos. 60/543,577; 60/643,629; and 60/643,378, all filed on Jan. 14, 2005, the entireties of which are all incorporated herein by reference.

The first ink optionally comprises one or more ceramic particles. Some examples of ceramic materials for optional inclusion in the particles include one or more of oxides, sulfides, carbides, nitrides, borides, tellurides, selenides, phosphides, oxycarbides, oxynitrides, titanates, zirconates, stannates, silicates, aluminates, tantalates, tungstates, glasses, doped and mixed metal oxides. For example, SiC, and BN are ceramics with high heat transfer coefficients and can be used in heat transfer fluids. Specific examples of some preferred oxides include silica, alumina, titania, magnesia, indium oxide, indium tin oxide and ceria. Moreover, the composition of the particles may be designed for any desired application.

In another aspect, the particles comprise alloy particles that include materials for hydrogen storage, such as, e.g., LaNi, FeTi, Mg₂Ni, and/or ZrV₂; materials for magnetic applications, such as, e.g., CoFe, CoFe₂, FeNi, FePt, FePd, CoPt, CoPd, SmCo₅, Sm₂Co₁₇, and/or Nd/B/Fe. For example, the particles could include core/shell particles, such as, metals coating metals (Ag/Cu, Ag/Ni), metals coating metal oxides (Ag/Fe₃O₄), metal oxides coating metals (SiO₂/Ag), metal oxides coating metal oxides (SiO₂/RuO₂), semiconductors coating semiconductors (Zns/CdSe) or combinations of all these materials.

The particles optionally comprise glass. The glass optionally comprises one or more low melting glasses with softening point below, e.g., about 500° C., about 400° C., about 300° C. The glass optionally is selected from borosilicates, lead borosilicates, or borosilicates comprising Al, Zn, Ag, Cu, In, Ba, or Sr. For example, the particles optionally comprise semiconducting metal oxides such as metal ruthenates. The metal oxide semiconductors optionally comprise one or more of: ruthenium oxide, metal ruthenates comprising M-Ru—O with various ratios of M to Ru where M can be Bi, Sr, Pb, Cu or another material, or pyrochlore phase. The semiconducting materials can comprise metal nitrides that semiconduct, e.g., TiN, and others.

In one preferred aspect of the invention, the inorganic material, discussed above, may form a thin layer, which surrounds, at least in part, a metallic core. For example, an outer silica layer may coat (optionally bond or adhere to) a metallic (e.g., silver) core. The inorganic material preferably inhibits agglomeration of the nanoparticles. Additionally or alternatively, the presence of the inorganic material in the nanoparticle in combination with a metallic core may cause the ultimately formed electronic feature to exhibit resistive properties.

The particles could include materials such as a semiconductor, a phosphor, an electrical conductor, a transparent electrical conductor, a thermochromic, an electrochromic, a magnetic material, a thermal conductor, an electrical insulator, a thermal insulator, a polishing compound, a catalyst, a pigment, or a drug or other pharmaceutical material.

In another aspect of the invention, the first ink comprises elemental carbon particles (micro- or nano-), such as in the form of graphite. Carbon is advantageous due to its very low cost and acceptable conductivity for many applications. In one embodiment, the first ink comprises one or more of particulate carbon, carbon black, modified carbon black, carbon nanotubes and/or carbon flakes. The inclusion of carbon in the first ink is highly desirable for the formation of resistors, as described in more detail below.

The particles can also be surface modified. For example, it may be advantageous to surface modify nanoparticles with materials such as a polymer, to prevent or inhibit agglomeration of the particles, particularly nanoparticles, due to their high surface energy. Such materials are referred to herein as “surface energy modifiers.” This concept is described, for example, by P. Y. Silvert et al. (Preparation of colloidal silver dispersions by the polyol process, Journal of Material Chemistry, 1997, volume 7(2), pp. 293-299). In one aspect, the polymer decomposes during heating thereby enabling the particles to sinter together. Preferred coatings for particles include sulfonated perfluorohydrocarbon polymer (e.g., NAFION, available from E.I. duPont deNemours, Wilmington, Del.), polystyrene, polystyrene/methacrylate, polyvinyl pyrrolidone, sodium bis(2-ethylhexyl) sulfosuccinate, tetra-n-octyl-ammonium bromide and alkane thiolates.

In another embodiment, the particles are coated with an intrinsically conducting polymer, which prevents or inhibits agglomeration in the composition and which provides a conductive path after solidification of the ink.

Additionally or alternatively, the particles may be “capped” with other compounds. The term capped refers to having compounds bonded to the outer surface of the particles without necessarily creating a coating over the outer surface. The particles used with the present invention can be capped with any functional group including organic compounds such as small organic molecules, polymers, organometallic compounds, and metal organic compounds. These capping agents can serve a variety of functions including the prevention of agglomeration of the particles, prevention of oxidation, enhancement of bonding of the particles to a surface, and enhancement of the flowability of the particles in an ink composition. Preferred capping agents that are useful with the particles of the present invention include amine compounds, organometallic compounds, and metal organic compounds.

5. Additives

A non-limiting list of exemplary additives that may be included in the first ink includes: crystallization inhibitors, polymers, polymer precursors (oligomers or monomers), binders, dispersants, surfactants, humectants, defoamers, pigments and the like.

In one embodiment, the additive comprises one or more crystallization inhibitors. Crystallization inhibitors minimize or prevent crystallization of the metal or metal-containing compound as the first ink dries. Various crystallization inhibitors are disclosed in U.S. Pat. No. 5,176,744 to Muller, the entirety of which is incorporated herein by reference.

Optionally, the additive includes polymers or polymer precursors, e.g., monomers or co-monomers. Thus, in one embodiment of the present invention, the first ink comprises one or more polymers or polymer precursors.

The polymers can be thermoplastic polymers or thermoset polymers. Thermoplastic polymers are characterized by being fully polymerized. They do not take part in any reactions to further polymerize or cross-link to form a final product. Typically, such thermoplastic polymers are melt-cast, injection molded or dissolved in a solvent. Examples include polyimide films, ABS plastics, vinyl, acrylic, styrene polymers of medium or high molecular weight and the like.

The polymers can also be thermoset polymers, which are characterized by not being fully polymerized or cured. The components that make up thermoset polymers must undergo further reactions to form fully polymerized, cross-linked or dense final products. Thermoset polymers tend to be resistant to solvents, heat, moisture and light.

A typical thermoset polymer mixture initially includes a monomer, resin or low molecular weight polymer. These components require heat, hardeners, light or a combination of the three to fully polymerize. Hardeners are used to speed the polymerization reactions. Some thermoset polymer systems are two part epoxies that are mixed at consumption or are mixed, stored and used as needed.

Specific examples of thermoset polymers include amine or amide-based epoxies such as diethylenetriamine, polyglycoldianine and triethylenetetramine. Other examples include imidazole, aromatic epoxies, brominated epoxies, thermoset PET, phenolic resins such as bisphenol-A, polymide, acrylics, urethanes and silicones. Hardeners can include isophoronediamine and meta-phenylenediamene.

According to a preferred embodiment, the polymer can also be an ultraviolet or other light-curable polymer. The polymers in this category are typically UV and light-curable materials that require photoinitiators to initiate the cure. Light energy is absorbed by the photoinitiators in the formulation causing them to fragment into reactive species, which can polymerize or cross-link with other components in the formulation. In acrylate-based adhesives, the reactive species formed in the initiation step are known as free radicals. Another type of photoinitiator, a cationic salt, is used to polymerize epoxy functional resins generating an acid, which reacts to create the cure. Examples of these polymers include cyanoacrylates such as z-cyanoacrylic acid methyl ester with an initiator as well as typical epoxy resin with a cationic salt.

The polymers can also be conducting polymers such as intrinsically conducting polymers. Conducting polymers are disclosed, for example, in U.S. Pat. No. 4,959,430 by Jonas et al., which is incorporated herein by reference in its entirety. Other examples of intrinsically conducting polymers that may be present in the first ink include: polyacetylenes such as poly[bis(benzylthio)acetylene], poly[bis(ethylthio)acetylene], and poly[bis(methylthio)acetylene]; polyaniline; poly(anilinesulfonic acid); polypyrrole; polythiophenes such as poly(thiophine-2.5-diyl), poly(3-alkylthiophene-2.5-diyl) wherein alkyl=butyl, hexyl, octyl, decyl, or dodecyl, and poly(styrenesulfonate)/poly-(2,3-dihydrothieno-[3,4-b]-1,4-dioxin); poly(1,4-phynylenevinylene) (PPV); poly(1,4-phenylene sulfide) or poly(fluroenyleneethynylene).

In another embodiment, the first ink comprises monomers and/or co-monomers of one or more of the above listed polymers. In this embodiment, the monomers and/or co-monomers may be reacted to form the polymers before, during, or after the application of the first ink to the first substrate.

In another embodiment, the additive comprises a binder, which acts to confine the first ink on the substrate. Binders restrict spreading of the first ink by methods other than substrate modification. The binder can be chosen such that it is a solid at room temperature, but is a liquid suitable for ink-jet deposition at higher temperatures. These compositions are suitable for deposition through, for example, a heated ink-jet head.

Binders can also be used to provide mechanical cohesion and limit spreading of the first ink after deposition. In one preferred embodiment, the binder is a solid at room temperature. During ink-jet printing, the binder is heated and becomes flowable. The binder can be a polymer or in some cases can be a precursor. In one embodiment, the binder is a solid at room temperature, when heated to greater than 50° C. the binder melts and flows allowing for ease of transfer and good wetting of the substrate, then upon cooling to room temperature the binder becomes solid again maintaining the shape of the deposited pattern. The binder can also react in some instances. Preferred binders include waxes, styrene allyl alcohols, poly alkylene carbonates, polyvinyl acetals, cellulose based materials, tetradecanol, trimethylolpropane and tetramethylbenzene. The preferred binders have good solubility in the solvent used in the ink and should be processable in the melt form. For example, styrene allyl alcohol is soluble in dimethylacetimide, solid at room temperature and becomes fluid-like upon heating to 80° C.

The binder in many cases should depart out of the ink-jet printed feature or decompose cleanly during thermal processing, leaving little or no residuals after processing the ink. The departure or decomposition can include vaporization, sublimation, unzipping, partial polymer chain breaking, combustion, or other chemical reactions induced by a reactant present on the substrate material, or deposited on top of the material.

An example of a precursor as a binder is the use of Ag-trifluoroacetate with DMAc. The DMAc will form adducts with the Ag-trifluoroacetate which then acts as a binder as well as the silver precursor.

If the first ink comprises particles, particularly nanoparticles, the first ink optionally further comprises one or more dispersants or dispersing agents, which are surface-modifying materials capable of inhibiting agglomeration of the particles. The dispersing agent may rely on physical or chemical interactions with the particles to promote dispersion. Preferably, at least a portion of the dispersing agent associates with a surface of the particles in the first ink in a way to inhibit agglomeration of the particles. As one example, the dispersant may be an amphiphile, with a polar portion that interacts with one of the particles and the liquid medium and a nonpolar portion that interacts with the other of the particles and the solvent or liquid vehicle, to promote maintenance of the particles therein in a dispersed state. The dispersing agent may be an ionic, nonionic or zwitterionic surfactant, or a polymer, that interacts with the surface of the particles. Some non-limiting examples of possible dispersing agents for use in polar and nonpolar liquid media include: ammonium salt of polyacrylic acid; ammonium salt of a polymeric carboxylic acid; sodium salt of a polymeric carboxylic acid; anionic macromolecular surfactant, condensed naphthalene sulfonic acid; methyl hydroxyethyl cellulose; monono-calcium salt of polymerized alkyl-aryl sulfonic acid; anionic and nonionic surfactants; polycarboxylic acid surfactant; polyoxyethylenesorbitan fatty acid ester; polyoxyethylene sorbitan monooleate; polyoxyethylene sorbitan monostearat; salts of polyfunctional oligomer; sodium dodecyl benzene sulfonate; sodium or ammonium salt of a sulfate ester an alkylphenoxypoly(ethyleneoxy)ethanol; sodium salt of a carboxylated polyelectrolyte; sodium salt of condensed naphthalene sulfonate; sodium salt of disulohonic acids; sodium salt of polyacrylic acids Polyacrylic acids; sodium salt of polymerized alkyl naphthalene sulfonic acid; sodium salt of polymerized alkyl-aryl sulfonic acid; sodium salts of polymerized substituted alkyl-aryl sulfonic acids; sodium salts of polymerized substituted benzoid alkyl sulfonic acids; sodium tetraborate; ammonium salt of carboxylated polyelectrolyte; alkylphenol ethoxylates; condensation product of naphthalene sulfonic acid formaldehyde; condensation product sulfo-succini acid ester of an alkoxylated novolak; nonylphenol novolak ethoxylate; condensation product of cresol-formaldehyde-schaffer salt; sodium salt of a cresol-formaldehyde condensation product; fatty acid methyl tauride sodium salt; phosphate of EO-PO-EO block polymer; 2,4,6-Tri-(1-phenylethyl)-phenol polyglycol ether phosphoric acid ester; 2,4,6-Tri-1(1-phenylethyl)-phenol polyglycol ether monophosphate triethanolamine salt; tri-sec,-butylphenol polyglycol ether phosphoric acid ester with 4 EO; alkyl polyglycol ether phosphoric acid ester with 6 EO; alkyl polyglycol ether phosphoric acid ester with 8 EO; 2,4,6-Tri-(1-phenylethyl)-phenol polyglycol ether sulfate ammonium salt; sulfosuccinic ester of ethoxylated castor oil; mannitol; sodium lauryl sulfate; and mono & disaccharides.

In another embodiment, the first ink comprises one or more surface energy modifiers, such as one or more surfactants. Surfactants, molecules with hydrophobic tails corresponding to lower surface tension and hydrophilic ends corresponding to higher surface tension, can be used to modify the first ink and/or substrates to achieve desirable surface tensions and the required interfacial energies. Surfactants may also be used to maintain particles, if present in the first ink, in suspension within the first ink.

For the purposes of this specification, hydrophobic means a material that does not have an affinity for, e.g., repels, water. Hydrophobic materials have low surface tensions. They also do not have functional groups capable of forming hydrogen bonds with water.

Hydrophilic means a material that has an affinity for water. Hydrophilic surfaces are wetted by water. Hydrophilic materials also have high values of surface tension. They can also form hydrogen bonds with water.

Co-solvents (humectants) can also be used to prevent the ink composition from crusting and clogging the orifice of the ink-jet head.

In another embodiment, the first ink further comprises one or more biocides that minimize or prevent bacterial growth over time. Possible biocides for inclusion in the first ink are well-known to those skilled in the art.

In one implementation of the invention, the first ink further comprises one or more pigments. The pigments may be used in a variety of industries including, but not limited to, displays (AMLCD), ink jet applications, household cleaner/brighteners, etc.

In one particular implementation of the present invention, the first ink comprises a combination of pigment materials. For example, the first ink may comprise a combination of two or more of pigments in order to create a color that cannot be created with a single pigment. As another example, the first ink may contain an inorganic pigment combined with an organic pigment. A layer of organic pigment on an inorganic pigment may also aid dispersion of the pigment in the first ink. The types and amounts of pigments that may be implemented in the first ink are well-known to those skilled in the art.

The first ink preferably is flowable (e.g., a fluid or paste), rigid or semi-rigid, such as in the form of a flexible tape. According to one embodiment, the first ink composition is a flowable ink composition that has a low viscosity, such as a viscosity of not greater than about 1000 centipoise, more preferably not greater than about 100 centipoise, e.g., not greater than about 60 centipoise or not greater than about 40 centipoise. As used herein, the viscosity is measured at a shear rate of about 132 Hz and under the relevant deposition conditions, particularly temperature. For example, some inks may be heated prior to deposition to reduce the viscosity and form a flowable ink composition.

In a preferred embodiment, the first ink has a surface tension of from about 15 to about 72 dynes/cm (e.g., from about 20 to about 60 dynes/cm or from about 25 to about 50 dynes/cm). These surface tensions are well-suited for ink jet applications.

B. The Primary Reducing Agent

1. Composition of the Primary Reducing Agent

An important application of the present invention is the ability to form conductive features on substrates that cannot be effectively processed at high temperatures. The use of the primary reducing agent permits the processing temperature to be maintained below the melting temperature of the substrate, whereas the processing temperature may exceed those limits without use of the reducing agent. Thus, one embodiment of the present invention is directed to a process for forming a conductive feature, which process includes the step of contacting the first ink with a primary reducing agent under conditions effective to reduce the metal in the metal-containing compound to its elemental form.

Thus, the metal precursor should be utilized in conjunction with a primary reducing agent (optionally derived from a second ink) to facilitate the formation of the elemental metal. As discussed in more detail below, the primary reducing agent may contact the first ink, which contains the metal precursor, either prior to first ink deposition, after first ink deposition or simultaneously with first ink deposition (for example, if the reducing agent comprises H₂ or forming gas, in which case the contacting occurs, at least in part during deposition of the first ink). That is, the steps of: (a) applying the first ink; and (b) contacting the first ink with the primary reducing agent, may occur sequentially (in either order) or simultaneously.

In a preferred embodiment, the primary reducing agent is selected from the group consisting of alcohols, aldehydes, amines, amides, alanes, boranes, borohydrides, aluminohydrides and organosilanes. More preferably, the primary reducing agent is selected from the group consisting of alcohols, amines, amides, boranes, borohydrides and organosilanes. A non-limiting exemplary list of primary reducing agents that may be implemented is provided below in Table 5.

TABLE 5
EXEMPLARY PRIMARY REDUCING AGENTS

| MATERIALS | SPECIFIC EXAMPLES |
|---|---|
| Amines | Triethyl amine; Amino |
| | propanol |
| Boranes | Borane- |
| | tetrahydrofuran |
| Borane adducts | Trimethylaminoborane |
| Borohydrides | Sodium borohydride, |
| | lithium borohydride |
| Hydrides | Tin hydride, lithium |
| | hydride, lithium |
| | aluminum hydride, |
| | sodium borohydride |
| Alcohols | Methanol, ethanol, |
| | isopropanol, terpineol, |
| | t-butanol, ethylene |
| | glycols, citrates, other |
| | polyols |
| Silanes | Dichlorosilane |
| Carboxylic acid | Formic acid |
| Aldehyde | Formaldehyde; octanal, |
| | decanal, dodecanal, |
| | glucose |
| Hydrazines | Hydrazine, hydrazine |
| | sulfate |
| Amides | Dimethylformamide |
| Phosphorous | Hypophosphoric Acid |
| compounds | |

Table 6 shows non-limiting examples of some preferred combinations of primary reducing agents and metal precursors that may be included in the present invention.

TABLE 6
EXEMPLARY METAL PRECURSOR/
PRIMARY REDUCING AGENT COMBINATIONS

| | PRIMARY REDUCING |
|---|---|
| METAL PRECURSOR | AGENT |
| Most Metal Nitrates | Amines (e.g. |
| | triethylamine), ethylene |
| | glycols, alcohols |
| | (terpineol), |
| | aminopropanol |
| Copper Nitrate | Long chain alcohols; |
| | citrates, carboxylates |
| Most Metal | Amines (e.g. |
| Carboxylates | triethylamine), ethylene |
| | glycols, alcohols |
| | (terpineol), |
| | aminopropanol |

2. The Second Ink

As mentioned above, in a preferred embodiment, a second ink is used to facilitate the conversion of the metal precursor to the corresponding elemental metal. Specifically, the second ink contains the primary reducing agent, which facilitates the formation of the elemental metal. Thus, as used herein, the term “second ink” means an ink composition (other than the first ink) comprising the primary reducing agent.

In one embodiment, the second ink is applied to an initial substrate to form the first substrate, which is subsequently coated, at least partially, with the first ink. In another embodiment, the second ink is applied to a substrate that has been at least partially coated with the first ink. Thus, the second ink may be applied to a substrate before or after the first ink has been applied to the substrate. In another embodiment, the second ink is applied substantially simultaneously with the application of the first ink. Thus, the order of the application of the inks is of little importance so long as the metal precursor contacts the primary reducing agent under conditions effective to reduce the metal in the metal precursor to its desired form, e.g., elemental metal.

In addition to the primary reducing agent, the second ink optionally further comprises one or more of the following: a liquid vehicle (e.g., solvent and/or liquid carrier), particulates, and/or additives. Since the primary reducing agent preferably is particularly active for converting the metal in the metal precursor to its elemental form, the second ink preferably does not include any metal precursors. It is contemplated, however, that the second ink may comprise a second metal precursor that is different from the metal precursor contained in the first ink. In this aspect, the first ink may comprise a reducing agent that is selectively reactive with the second metal precursor contained in the second ink. Thus, in this aspect, the primary reducing agent in the second ink selectively reacts with the metal precursor in the first ink, and the reducing agent in the first ink selectively reacts with the second metal precursor in the second ink.

The amounts and types of these optional additional compositions that may be included in the second ink are substantially as described in detail above with reference to the first ink, which description is incorporated in this section by its entirety as if the description referred to the second ink rather than the first ink.

In a preferred aspect, the second ink further comprises metal nanoparticles (as described above with reference to the first ink) in an amount from about 1 volume percent to about 60 volume percent, e.g., from about 10 to about 60 volume percent or from about 30 to about 40 volume percent, based on the total volume of the second ink. The metal nanoparticles preferably are selected from the group consisting of silver nanoparticles, copper nanoparticles and nickel nanoparticles. Additionally or alternatively, the second ink further comprises one or more of particulate carbon, carbon black, modified carbon black, carbon nanotubes and/or carbon flakes.

If the first ink comprises capped particulates, then the second ink optionally further comprises a cap stripping agent capable of removing the caps from the particulates. In one embodiment, the cap stripping agent comprises an organic solvent in which the cap is highly soluble and which is able to weaken the bond between the cap and the particulates. In another embodiment, the cap stripping agent comprises a reagent that reacts with the capped particulates to form a new compound that does not bind to the particulates (or is less binding than the cap) and thus forming particulates having an exposed uncapped surface. Conversely, if the second ink comprises capped particulates, then the first ink preferably comprises a cap stripping agent capable of removing the caps from the particulates.

In another embodiment, the second ink comprises a flocculent, which is defined herein as a composition (other than a reducing agent) that facilitates the precipitation of the elemental metal from the metal precursor. Flocculents are often materials of opposite charge to the precursor material. Therefore, if the precursor is anionic, a flocculent is picked from cationic materials, such as polyvalent metal salts, e.g., Ca⁺², Mg⁺², Al⁺³, Zn⁺². In another aspect, the flocculent comprises a polyelectrolyte. Non-limiting examples include salts of polyethylene imine, or quaternary ammonium salts of polyamine polymers. In addition, the flocculent can be material of opposite charge such as a single quaternary ammonium salt. Examples include octyltrimethylammonium chloride, CTAB (cetyltrimethylammonium bromide) and related materials. In another aspect, the flocculent comprises a mobile species such as H⁺, which can be provided using a number of organic acids such as acetic acid, citric acid, glycolic acid, etc. If the precursor is cationic, the flocculent may be selected from polyanionic materials such as phosphates, sulfates, polyanionic polymers, etc. If implemented in the present invention, it is preferred that the flocculent be included in the second ink rather than the first ink so that as the first ink contacts the second ink the flocculent interacts with the reacting metal precursor to facilitate elemental metal formation.

In one embodiment, the invention is directed to the second ink itself, also referred to herein as a “reducing agent composition.” The second ink is suitable for direct write, e.g., ink jet, printing and comprises or consists essentially of a primary reducing agent dissolved in a solvent, at least in part. The second ink of this embodiment of the present invention is capable of reducing a metal in a metal precursor to its elemental form. The second ink preferably has a surface tension of from about 10 to about 72 dynes/cm, e.g., from about 15 to about 72 dynes/cm, from about 20 to about 60 dynes/cm or from about 25 to about 40 dynes/cm, and a viscosity of not greater than about 1000 centipoise. In another aspect, the surface tension of the second ink (e.g., of the primary reducing agent) is less than the surface tension of the first ink.

The amount of primary reducing agent contained in the second ink will vary widely depending, inter alia, on the reaction conditions and on the selected metal precursor. Preferably, the second ink comprises the primary reducing agent in an amount equal to or greater than the minimum stoichiometric amount necessary to convert all of the metal in the metal precursor (derived from the first ink) to its elemental form at the desired conversion conditions. That is, the amount of primary reducing agent provided by the second ink is in excess relative to the amount metal precursor to be converted to elemental form.

The acidity or basicity of second ink also may vary widely, depending, in part, on the acidity or basicity of the first ink. In one embodiment, the second ink is acidic, having a pH less than 7. Alternatively, the second ink is basic, having a pH greater than 7. In terms of ranges, the second ink optionally has a pH of from about 2 to about 10, e.g., from about 5 to about 7 or from about 7 to about 9. The second ink optionally further comprises a pH modifier, e.g., a buffering agent.

In these aspects, the acidity or basicity of the second ink preferably inversely corresponds with the acidity of basicity of the first ink that may be used in conjunction with the second ink. For example, if the second ink has a pH of from about 7 to about 9, the first ink preferably has a pH of from about 5 to about 7. Conversely, if the second ink has a pH of from about 5 to about 7, the first ink preferably has a pH of from about 7 to about 9. More broadly, if the first ink has a pH greater than about 7, the second ink preferably has a pH of less than 7; if the first ink has a pH less than about 7, the second ink preferably has a pH greater than about 7.

3. Pre-Formed Reducing Agent Coated Substrates

In one embodiment, the present invention is directed to a substrate suitable for receiving an ink jetted ink, the substrate comprising: (a) a support material having a surface; and (b) a primary reducing agent disposed over at least a portion of the surface. The substrate of this embodiment of the present invention is thus coated, at least partially, with the primary reducing agent and is capable of receiving a first ink thereon. As the first ink contacts the primary reducing agent on the pre-formed substrate, the metal in the metal precursor in the first ink is reduced to form its corresponding elemental metal.

Thus, in this embodiment, the preformed substrate comprises a reducing agent layer and an underlying support layer, which may comprise any of the substrate materials described in more detail below. The reducing agent layer comprises the primary reducing agent and has an external surface. In preparing a conductive feature on the preformed substrate, the first ink is applied to at least a portion of the external surface of the reducing agent layer. As the first ink is applied to the external surface, the primary reducing agent may solubilize into the liquid vehicle (solvent and/or carrier medium) from the first ink causing the metal precursor in the first ink to contact the primary reducing agent under conditions effective to reduce the metal precursor to its elemental form and form the conductive feature.

The preformed substrate may be formed by a variety of means so long as the primary reducing agent is disposed over at least a portion of the substrate. In one embodiment, the second ink is applied to the substrate surface through any of a number of various printing processes, e.g., intaglio printing, gravure printing, lithographic printing, and flexographic printing, over the entire substrate surface, over a majority of the substrate surface or over a minority of the substrate surface. In another aspect, the second ink is applied to the substrate surface via a direct write (e.g., ink jet) printing technique.

In one embodiment, the second ink is applied in a predetermined pattern over the substrate surface, for example for relatively expensive second inks. That is, after applying the second ink in a predetermined pattern on the substrate, the second ink (and hence, the primary reducing agent contained therein) is selectively disposed in a pattern over a portion of the substrate surface. In this aspect, the first ink preferably is subsequently applied to the pre-formed substrate also in a predetermined pattern which may or may not correspond with the predetermined pattern previously used for the second ink. Preferably, the first ink is applied in a manner that substantially overlaps the second ink.

The support material in this embodiment may be any of the substrate materials described herein. In one preferred embodiment, the support material has opposing major planar surfaces. For example, the support material optionally is selected from the group consisting of paper, cardboard, glass and plastic (e.g., a plastic sheet). In this aspect, the second ink (and primary reducing agent) might be disposed on all or a portion of one or both of the opposing major planar surfaces. For example, the primary reducing agent may be disposed over at least 90 percent of one or both opposing major planar surfaces.

After the second ink is applied to the substrate surface, it is desirable to remove the liquid components, e.g., liquid vehicle, contained in the second ink. In this aspect, the second ink may simply be allowed to dry, optionally with heating, to form a dry substrate. Optionally, the liquid component removal is facilitated by application of a vacuum. Of course, if the second ink is allowed to dry prior to application of the first ink thereon, it is desirable that the primary reducing agent remain on the substrate surface rather than vaporize. Accordingly, in this embodiment, it is desirable for the reducing agent in the second ink to be relatively non-volatile so it will remain disposed on the substrate surface after the liquid components in the second ink have vaporized. Primary reducing agents having molecular weights greater than about 150, preferably greater than about 500 and most preferably greater than about 1,000 should provide desirable volatilities so as to remain on the substrate surface after liquid component vaporization.

C. Application of the Inks

The ink compositions of the present invention (e.g., the first ink and/or the second ink) can be deposited onto surfaces (e.g., the first substrate, second substrate or an initial substrate) using a variety of tools and methods.

As indicated above, the first ink and/or the second ink, in either order, may be selectively applied in a predetermined pattern to the substrate. For example, in one embodiment, the second ink is selectively applied in a predetermined pattern to an initial substrate to form the first substrate, on which the first ink is applied, optionally also in a predetermined pattern, which at least partially overlaps the predetermined pattern formed by the second ink. In an alternative embodiment, the first ink is selectively applied in a predetermined pattern to the first substrate to form a coated substrate, on which the second ink is applied. The second ink optionally also is applied in a predetermined pattern, which at least partially overlaps the predetermined pattern formed by the first ink. Thus, in one aspect, the first ink may be selectively applied to the first substrate in a first predetermined pattern to form the at least partially coated substrate, and, optionally, the second ink comprising the primary reducing agent may be selectively applied to the at least partially coated substrate in a second predetermined pattern.

As used herein, a low viscosity deposition tool is a device that deposits a liquid or liquid suspension onto a surface by ejecting the composition through an orifice toward the surface without the tool being in direct contact with the surface. The low viscosity deposition tool is preferably controllable over an x-y grid, referred to herein as a direct-write deposition tool. A preferred direct-write deposition tool is an ink-jet device. Other examples of direct-write deposition tools include aerosol jets and automated syringes, such as the MICROPEN tool, available from Ohmcraft, Inc., of Honeoye Falls, N.Y.

For use in an ink-jet device, the viscosities of the ink compositions are preferably not greater than 50 centipoise, such as in the range of from about 10 to about 40 centipoise. For use in aerosol jet atomization, the viscosity is preferably not greater than about 20 centipoise. Automated syringes can use compositions having a higher viscosity, such as up to about 5000 centipoise.

A preferred direct-write deposition tool is an ink-jet device. Ink-jet devices operate by generating droplets of the ink composition and directing the droplets toward a surface. The position of the ink-jet head is carefully controlled and can be highly automated so that discrete patterns of the composition can be applied to the surface. Ink-jet printers are capable of printing at a rate of 1000 drops per jet per second or higher and can print linear features with good resolution at a rate of 10 cm/sec or more, up to about 1000 cm/sec. Each drop generated by the ink-jet head includes approximately 5 to 100 picoliters of the composition, which is delivered to the surface. For these and other reasons, ink-jet devices are a highly desirable means for depositing materials onto a surface.

Typically, an ink-jet device includes an ink-jet head with one or more orifices having a diameter of not greater than about 100 μm, such as from about 20 μm to 75 μm. Droplets are generated and are directed through the orifice toward the surface being printed. Ink-jet printers typically utilize a piezoelectric driven system to generate the droplets, although other variations are also used. Ink-jet devices are described in more detail in, for example, U.S. Pat. No. 4,627,875 by Kobayashi et al. and U.S. Pat. No. 5,329,293 by Liker, each of which is incorporated herein by reference in their entirety. However, such devices have primarily been used to deposit inks of soluble dyes or dispersed pigments or dyes.

In a particularly preferred embodiment, the first ink is contained in a first ink source, which is in fluid communication with a first ink-jet head. The second ink is contained in a second ink source, which is in fluid communication with a second ink-jet head. In this embodiment, the first and second ink-jet heads may eject the first and second inks, respectively, on a substrate much in the same manner as a conventional color ink-jet printer prints various colors (e.g., red, green and blue) onto a piece of paper. In this embodiment, the first and second inks may be applied to the substrate in predetermined patterns, which preferably overlap with one another so that the primary reducing agent in the second ink sufficiently contacts the metal precursor in the first ink to form the conductive feature.

It is also important to simultaneously control the surface tension and the viscosities of the ink compositions to enable the use of industrial ink-jet devices. Preferably, the surface tension is from about 15 to 72 dynes/cm, such as from about 25 to 50 dynes/cm, while the viscosity is maintained at not greater than about 50 centipoise.

One or more of the ink compositions according to the present invention (e.g., the first and/or second inks) can also be deposited by aerosol deposition. Aerosol deposition can enable the formation of a coating. In aerosol deposition, the ink composition is aerosolized into droplets and the droplets are transported to the substrate in a flow gas.

The aerosol can be created using a number of atomization techniques. Examples include ultrasonic atomization, two-fluid spray head, pressure atomizing nozzles and the like. Ultrasonic atomization is preferred for compositions with low viscosities and low surface tension. Two-fluid and pressure atomizers are preferred for higher viscosity fluids. Solvent or other precursor components can be added to the ink during atomization, if necessary, to keep the concentration of precursor components substantially constant during atomization.

The size of the aerosol droplets can vary depending on the atomization technique. In one embodiment, the average droplet diameter size is not greater than about 50 μm and more preferably is not greater than about 25 μm.

The droplets are deposited onto the surface of the substrate by inertial impaction of larger droplets, electrostatic deposition of charged droplets, diffusional deposition of sub-micron droplets, interception onto non-planar surfaces and settling of droplets, such as those having a size in excess of about 10 μm.

Examples of tools and methods for the deposition of fluids using aerosol deposition include U.S. Pat. No. 6,251,488 by Miller et al., U.S. Pat. No. 5,725,672 by Schmitt et al. and U.S. Pat. No. 4,019,188 by Hochberg et al. Each of these U.S. patents is incorporated herein by reference in their entirety.

The first ink and/or second ink can also be applied by a variety of other techniques including intaglio printing, gravure printing, lithographic printing and flexographic printing. Other deposition techniques include roll printer, spraying, dip coating, spin coating, and other techniques that direct discrete units of fluid or continuous jets, or continuous sheets of fluid to a surface.

For example, gravure printing can be used with inks having a viscosity of up to about 5000 centipoise. The gravure method can deposit features having an average thickness of from about 1 μm to about 25 μm micrometers and can deposit such features at a high rate of speed, such as up to about 700 meters per minute. The gravure process also enables the direct formation of patterns onto the surface.

Lithographic printing methods can also be utilized. In the lithographic process, the inked printing plate contacts and transfers a pattern to a rubber blanket and the rubber blanket contacts and transfers the pattern to the surface being printed. A plate cylinder first comes into contact with dampening rollers that transfer an aqueous solution to the hydrophilic non-image areas of the plate. A dampened plate then contacts an inking roller and accepts the ink only in the oleophillic image areas.

The ink compositions can also be in the form of a tape such that the ink composition is not flowable absent the application of some external force or additional chemical. The conductive feature is formed by chemically or mechanically transferring the material contained within the tape to a substrate. According to one embodiment, a method for the deposition of a conductive feature is provided that includes the steps of providing a substrate, providing a tape composition including at least a metal precursor, positioning the tape composition over the substrate and selectively depositing a primary reducing agent onto the tape composition, wherein the primary reducing agent reduces the metal precursor to a metal and transfers the metal to the substrate to form a conductive feature. According to an alternative embodiment, a method for the deposition of a conductive feature includes the steps of providing a substrate, providing a tape composition including at least a primary reducing agent, positioning the tape composition over the substrate, and selectively depositing an ink composition having at least a metal precursor onto the tape composition, wherein the reducing agent reduces the metal precursor compound to a metal and forms a conductive feature.

According to an alternative embodiment, both the primary reducing agent and the first ink can be provided in the form of individual tapes or as a multi-layer composite tape. According to one embodiment, a method for the fabrication of a conductive feature on a substrate is provided that includes the steps of providing a tape composition, the tape composition having a first layer including the primary reducing agent and an adjacent second layer including a metal precursor, positioning the tape composition over a substrate, and transferring the first layer and the second layer to the substrate to form a conductive feature on the substrate. According to another embodiment, a solvent is printed onto the tape and used to mix the first and second layers and transfer them to the substrate.

According to this embodiment, the tape can be transferred using chemical means or mechanical means. For example, a chemical that has the ability to solubilize both the tape layers can be applied to cause the tape layers to flow onto the substrate disposed beneath the tape layers. The chemical solvent can be deposited using a direct-write device such as an ink-jet to form a pre-determined pattern on the substrate. Alternatively, mechanical means including lasers can be used to transfer the tape to the substrate. Various processes for depositing electronic features with tapes are disclosed, for example, in PCT International Publication No. WO 03/035279, which claims priority to U.S. Provisional Patent Application Ser. No. 60/348,223, filed on Oct. 19, 2001, the entirety of which is incorporated herein by reference.

Using one or more of the foregoing deposition techniques, it is possible to deposit the ink compositions (the first and/or second inks) on one side or both sides of a substrate. Further, the processes can be repeated to deposit multiple layers of various precursors on a substrate.

D. Contacting Conditions

The conditions under which the first ink contacts the primary reducing agent may vary depending, for example, on the reactivity of the metal precursor with the primary reducing agent. Preferably, the amount and type of primary reducing agent is such that when it contacts the first ink, the metal precursor is converted to the corresponding elemental metal at or below about 200° C., preferably at or below about 100° C. and most preferably near room temperature (e.g., not greater than about 50° C.). Thus, in one aspect of the invention, the steps of (a) applying the first ink; and (b) contacting the first ink with the primary reducing agent occur at less than about 200° C., e.g., less than about 150° C., less than about 100° C. and most preferably near room temperature.

In another embodiment, the conversion of the metal precursor occurs at a slightly elevated temperature, e.g., caused by heating. For example, heat may be applied to the deposited first ink composition as or after it contacts the primary reducing agent. In terms of ranges, the contacting optionally occurs at a temperature ranging from about 25° C. to about 200° C., e.g., from about 50° C. to about 200° C. or from about 50° C. to about 150° C.

In one embodiment, the contacting conditions are such that the metal precursor is converted to the elemental metal relatively quickly. In a preferred embodiment, a majority of the metal (e.g., at least about 50 weight percent, at least about 75 weight percent and most preferably at least about 95 weight percent of the metal) in the metal precursor is reduced to its elemental form in less than 10 seconds, more preferably less than 5 seconds, and most preferably less than 1 second after contacting the primary reducing agent. Such quick reducing times are highly desirable so that migration of the inks is minimized.

E. The Substrate

Desirably, the ink compositions (e.g., the first ink or second ink) according to the present invention can be deposited and converted to the conductive feature at low temperatures, thereby enabling the use of a variety of substrates having a relatively low melting or decomposition temperature. During conversion of the ink compositions to the conductive feature, the substrate surface can significantly influence how the conversion to a conductive feature occurs.

The types of substrates that are particularly useful according to the present invention include polyfluorinated compounds, polyimides, epoxies (including glass-filled epoxy), polycarbonates and other polymers. Other useful low-cost substrates include cellulose-based materials, such as wood, paper, cardboard, or other wood pulp based materials, acetate, polyester, such as PET or PEN, polyethylene, polypropylene, polyvinyl chloride, acrylonitrile, butadiene (ABS), flexible fiber board, non-woven polymeric fabric, cloth, metallic foil, silicon, and glass. In another embodiment, the substrate comprises a component selected from the group consisting of an organic substrate, a glass substrate, a ceramic substrate, paper and a polymeric substrate. The substrate can be coated, for example a dielectric on a metallic foil. Although the present invention can be used for such low-temperature substrates, it will be appreciated that traditional substrates such as ceramic substrates can also be used in accordance with the present invention.

According to a preferred embodiment of the present invention, the substrate onto which the ink composition is deposited and converted to a conductive feature optionally has a softening point of not greater than about 225° C., preferably not greater than about 200° C., even more preferably not greater than about 185° C. even more preferably not greater than about 150° C. and even more preferably not greater than about 100° C.

The processes of the present invention also enable the formation of conductive features onto non-planar substrates, such as curved substrates or substrates that have a stepped feature on the substrate surface. The conductive features can also be well adhered, such that a flexible substrate can be rolled or otherwise flexed without damaging the integrity of the conductive feature.

III. Conductive Features

In another embodiment, the present invention is directed to conductive features. The conductive features of the present invention may be formed according to one or more of the various processes for forming conductive features, which processes are described in detail above. It is contemplated, however, that the conductive features of the present invention may be formed by other heretofore unknown processes.

The conductive features preferably are disposed on a substrate, as described above. The features preferably have a minimum feature size of not greater than about 200 μm, more preferably not greater than about 100 μm, even more preferably not greater than about 75 μm, even more preferably not greater than about 50 μm and most preferably not greater than about 25 μm. In some embodiments, the minimum feature size can be not greater than about 10 μm. The minimum feature size is the size of the smallest dimension of a feature in the x-y plane, such as the width of a conductive trace.

Additionally, the conductive features of the present invention may have a wide range of electrical characteristics depending on the type of electrical feature desired and the components in the first and/or second inks. Depending on the ink compositions, the conductive feature may be a highly conductive feature, a resistor or a dielectric.

A. Highly Conductive Features

The conductive features formed according to various embodiments of the present invention can have good electrical properties. For example, the conductive features can have a resistivity that is not greater than about 1000 times the resistivity of the bulk conductor (metal), such as not greater than about 500 times the resistivity of the bulk conductor, preferably not greater than about 100 times the resistivity of the bulk conductor and even more preferably not greater than about 50 times the resistivity of the bulk conductor. In particularly conductive embodiments, the conductive features have a resistivity that is not greater than about 40 times the resistivity of the bulk conductor, such as not greater than about 20 times the resistivity of the bulk conductor, or even not greater than about 10 times the resistivity of the bulk conductor, preferably not greater than 6 times the resistivity of the bulk conductor, more preferably not greater than about 4 times the resistivity of the bulk conductor and even more preferably not greater than about 2 times the resistivity of the bulk conductor.

B. Resistors

In contrast to the above-described highly conductive embodiments of the present invention, the present invention also is directed to resistors, or conductive features having a resistivity typical of resistors. Resistors can be formed, for example, by including one or more insulators (or insulator precursor compositions) in the first and/or second inks, which insulators have a lower conductivity than the bulk metal of the metal precursor in the first ink. As used herein, the term “insulator” means a composition (or precursor to a composition) having a conductivity less than the conductivity of the bulk metal that corresponds to the metal in the metal precursor contained in the first ink. The resulting conductive feature will thus have two phases: a (typically) high conductivity phase and an insulating phase. In a preferred embodiment, carbon is included in the first and/or second ink composition, as described in detail above, to provide the insulating phase of the conductive feature. A non-limiting list of insulators that may be included in the first and/or second ink includes: carbon, silica, alumina, titania, zirconia, silicon monoxide and glass, with carbon being a particularly preferred insulator.

The amount of insulator contained in the first and/or second ink may vary widely depending on the desired resistivity of the conductive feature ultimately to be formed, the conductivity of the insulator, and the amount of metal precursor in the first ink. In one embodiment, the first ink comprises the insulator in an amount from about 10 to about 50 weight percent, based on the total weight of the first ink. In another embodiment, the insulator may be present in the second ink (or on a preformed substrate), optionally in any of the amounts specified above with reference to the first ink.

In various embodiments, the weight percentage of the elemental metal phase (conductive phase) in the conductive feature ranges from about 1 to about 95 weight percent, e.g., from about 1 to about 70 weight percent, from about 10 to about 50 weight percent, from about 50 to about 95 weight percent or from about 40 to about 70 weight percent, based on the total weight of the conductive feature. The balance optionally comprising the insulating (e.g., carbon) phase.

Depending on the amount of insulating phase in the conductive feature, the resistivity of the conductive feature may vary widely. In one embodiment, conductive feature has a resistivity of at least about 1000 μΩ-cm, such as at least about 10,000 μΩ-cm and even at least about 100,000 μΩ-cm. Optionally in combination with any one of these lower limits, the conductive feature of the present invention preferably has a resistivity of no greater than about 1,000,000 μΩ-cm.

IV. Exemplary Applications

The compositions and process of the present invention can be utilized to fabricate a number of devices where the overall cost of the device must remain low. The following is a non-limiting description of the types of devices and components to which the methods and compositions of the present invention are applicable.

The compositions and processes of the present invention can also be utilized to fabricate novelty electronics, such as for games and greeting cards or lottery tickets. As is discussed above, the compositions can advantageously be deposited and reacted on cellulose-based materials such as paper or cardboard for use in such novelty electronics. The composition can be formulated to provide an aesthetically pleasing color, if desired, by incorporating a dye into the formulation.

The compositions and methods of the present invention can also be utilized to fabricate sensors, such as sensors that can be attached to perishable food products to track temperature over a period of time.

The compositions and methods of the present invention can also be utilized to fabricate interconnects (e.g., touch pads) that are useful in a variety of electronic devices.

The compositions and methods of the present invention can also be used to fabricate security-related devices

In one embodiment, the surface to be printed onto is not planar and a non-contact printing approach is used. The non-contact printing approach can be ink-jet printing or another technique providing deposition of discrete units of fluid onto the surface. Examples of surfaces that are non-planar include in windshields, electronic components, electronic packaging and visors.

The compositions and methods provide the ability to print disposable electronics such as for games included in magazines. The compositions can advantageously be deposited and reacted on cellulose-based materials such as paper or cardboard. The cellulose-based material can be coated if necessary to prevent bleeding of the ink(s) into the substrate. For example, the cellulose-based material could be coated with a UV curable polymer.

The compositions and processes of the present invention can also be used to fabricate microelectronic components such as multichip modules, particularly for prototype designs or low-volume production

Another technology where the direct-write deposition of electronic features provides significant advantages is for flat panel displays, such as plasma display panels. Ink-jet deposition of electronic powders is a particularly useful method for forming the electrodes for a plasma display panel. The electronic powders and deposition method can advantageously be used to form the electrodes, as well as the bus lines and barrier ribs, for the plasma display panel. Typically, a metal paste is printed onto a glass substrate and is fired in air at from about 450° C. to about 600° C. Direct-write deposition of low viscosity inks offers many advantages over paste techniques including faster production time and the flexibility to produce prototypes and low-volume production applications. The deposited features will have high resolution and dimensional stability, and will have a high density.

Another type of flat panel display is a field emission display (FED). The deposition method of the present invention can advantageously be used to deposit the microtip emitters of such a display. More specifically, a direct-write deposition process such as an ink-jet deposition process can be used to accurately and uniformly create the microtip emitters on the backside of the display panel.

Another type of electronic powder to which the present invention is applicable is transparent conducting powder, particularly indium-tin oxide, referred to as ITO, Zn—Al—O, ATO and Zn—Ga—Al—O. Such materials are used as electrodes in display applications, particularly for thin-film electroluminescent (TFEL) displays. The electrode patterns of ITO can advantageously be deposited using the direct-write method of the present invention including an ink-jet, particularly to form discrete patterns of indicia, or the like.

The present invention is also applicable to inductor-based devices including transformers, power converters and phase shifters. Examples of such devices are illustrated in: U.S. Pat. No. 5,312,674 by Haertling et al.; U.S. Pat. No. 5,604,673 by Washburn et al.; and U.S. Pat. No. 5,828,271 by Stitzer. Each of the foregoing U.S. patents is incorporated herein by reference in their entirety. In such devices, the inductor is commonly formed as a spiral coil of an electrically conductive trace, typically using a thick-film paste method. To provide the most advantageous properties, the metalized layer, which is typically silver, must have a fine pitch (line spacing). The output current can be greatly increased by decreasing the line width and decreasing the distance between lines. The direct-write process of the present invention is particularly advantageous for forming such devices, particularly when used in a low-temperature cofired ceramic package (LTCC).

The present invention can also be used to fabricate antennas such as antennas used for cellular telephones. The design of antennas typically involves many trial and error iterations to arrive at the optimum design. The direct-write process of the present invention advantageously permits the formation of antenna prototypes in a rapid and efficient manner, thereby reducing a product development time. Examples of microstrip antennas are illustrated in: U.S. Pat. No. 5,121,127 by Toriyama; U.S. Pat. No. 5,444,453 by Lalezari; U.S. Pat. No. 5,767,810 by Hagiwara et al.; and U.S. Pat. No. 5,781,158 by Ko et al. Each of these U.S. patents is incorporated herein by reference in their entirety. The methodology of the present invention can be used to form the conductors of an antenna assembly.

The inks and methods of the present invention can also be used to apply underfill materials that are used below electronic chips to attach the chips to surfaces and other components. Hollow particles are particularly advantageous because they are substantially neutrally buoyant. This allows the particles to be used in underfill applications without settling of the particles in the liquid between the chip and surface below. Further, the spherical morphology of the particles allows them to flow better through the small gap. This significantly reduces the stratification that is often observed with dense particles. Further, very high thermal conductivity is not required and therefore silica is often used in this application. In other applications, the material must be thermally conductive but not electrically conductive. Materials such as boron nitride (BN) can then be used.

Additional applications enabled by the inks and processes of the present invention include low cost or disposable electronic devices such as electronic displays, electrochromic, electrophoretic and light-emitting polymer-based displays. Other applications include circuits imbedded in a wide variety of devices such as low cost or disposable light-emitting diodes, solar cells, portable computers, pagers, cell phones and a wide variety of internet compatible devices such as personal organizers and web-enabled cellular phones. The present invention also enables a wide variety of security and authentication applications. For example, with the advent and growth of desktop publishing and color-photocopiers, the opportunities for document and coupon fraud have increased dramatically. The present invention has utility in a variety of areas including coupon redemption, inventory security, currency security, compact disk security and driver's license and passport security. The present invention can also be utilized as an effective alternative to magnetic strips. Presently, magnetic strips include identification numbers such as credit card numbers that are programmed at the manufacturer. These strips are prone to failure and are subject to fraud because they are easily copied or modified. To overcome these shortcomings, circuits can be printed on the substrate and encoded with specific consumer information. Thus, the present invention can be used to improve the security of credit cards, ATM cards and any other tracking card, which uses magnetic strips as a security measure.

The compositions and methods of the present invention can also produce conductive patterns that can be used in flat panel displays. The conductive materials used for electrodes in display devices have traditionally been manufactured by commercial deposition processes such as etching, evaporation, and sputtering onto a substrate. In electronic displays it is often necessary to utilize a transparent electrode to ensure that the display images can be viewed. Indium tin oxide (ITO), deposited by means of vacuum-deposition or a sputtering process, has found widespread acceptance for this application. U.S. Pat. No. 5,421,926 by Yukinobu et al. discloses a process for printing ITO inks. For rear electrodes (i.e., the electrodes other than those through which the display is viewed) it is often not necessary to utilize transparent conductors. Rear electrodes can therefore be formed from conventional materials and by conventional processes. Again, the rear electrodes have traditionally been formed using costly sputtering or vacuum deposition methods. The inks and processes of the present invention allow the direct deposition of metal electrodes onto low temperature substrates such as plastics. For example, a silver precursor composition (first ink) can be inkjet printed and heated at 150° C. to form 150 μm by 150 μm square electrodes with excellent adhesion and sheet resistivity values of less than 1 ohm per square.

In one embodiment, the inks and processes of the present invention are used to interconnect electrical elements on a substrate, such as non-linear elements. Non-linear elements are defined herein as electronic devices that exhibit nonlinear responses in relationship to a stimulus. For example a diode is known to exhibit a nonlinear output-current/input-voltage response. An electroluminescent pixel is known to exhibit a non-linear light-output/applied-voltage response. Nonlinear devices also include but are not limited to transistors such as TFT's and OFETs, emissive pixels such as electroluminescent pixels, plasma display pixels, field emission display (FED) pixels and organic light emitting device (OLED) pixels, non emissive pixels such as reflective pixels including electrochromic material, rotatable microencapsulated microspheres, liquid crystals, photovoltaic elements, and a wide range of sensors such as humidity sensors.

Nonlinear elements, which facilitate matrix addressing, are an essential part of many display systems. For a display of M×N pixels, it is desirable to use a multiplexed addressing scheme whereby M column electrodes and N row electrodes are patterned orthogonally with respect to each other. Such a scheme requires only M+N address lines (as opposed to M×N lines for a direct-address system requiring a separate address line for each pixel). The use of matrix addressing results in significant savings in terms of power consumption and cost of manufacture. As a practical matter, the feasibility of using matrix addressing usually hinges upon the presence of a nonlinearity in an associated device. The nonlinearity eliminates crosstalk between electrodes and provides a thresholding function. A traditional way of introducing nonlinearity into displays has been to use a backplane having devices that exhibit a nonlinear current/voltage relationship. Examples of such devices include thin-film transistors (TFT) and metal-insulator-metal (MIM) diodes. While these devices achieve the desired result, they involve thin-film processes, which suffer from high production costs as well as relatively poor manufacturing yields.

The present invention allows the direct printing of the conductive components of nonlinear devices including the source the drain and the gate. These nonlinear devices may include directly printed organic materials such as organic field effect transistors (OFET) or organic thin film transistors (OTFT), directly printed inorganic materials and hybrid organic/inorganic devices such as a polymer based field effect transistor with an inorganic gate dielectric. Direct printing of these conductive materials will enable low cost manufacturing of large area flat displays.

The compositions and methods of the present invention produce conductive patterns that can be used in flat panel displays to form the address lines or data lines. The lines may be made from transparent conducting polymers, transparent conductors such as ITO, metals or other suitable conductors. The present invention provides ways to form address and data lines using deposition tools such as an ink-jet device. The inks of the present invention allow printing on large area flexible substrates such as plastic substrates and paper substrates, which are particularly useful for large area flexible displays. Address lines may additionally be insulated with an appropriate insulator such as a non-conducting polymer or other suitable insulator. Alternatively, an appropriate insulator may be formed so that there is electrical isolation between row conducting lines, between row and column address lines, between column address lines or for other purposes. These lines can be printed with a thickness of about 1 μm and a line width of 100 μm by ink-jet printing the metal precursor composition. These data lines can be printed continuously on large substrates with an uninterrupted length of several meters. Surface modification can be employed, as is discussed above, to confine the composition and to enable printing of lines as narrow as 10 μm. The deposited lines can be heated to 200° C. to form metal lines with a bulk conductivity that is not less than 10 percent of the conductivity of the equivalent pure metal.

Flat panel displays may incorporate emissive or reflective pixels. Some examples of emissive pixels include electroluminescent pixels, photoluminescent pixels such as plasma display pixels, field emission display (FED) pixels and organic light emitting device (OLED) pixels. Reflective pixels include contrast media that can be altered using an electric field. Contrast media may be electrochromic material, rotatable microencapsulated microspheres, polymer dispersed liquid crystals (PDLCs), polymer stabilized liquid crystals, surface stabilized liquid crystals, smectic liquid crystals, ferroelectric material, or other contrast media well known in art. Many of these contrast media utilize particle-based non-emissive systems. Examples of particle-based non-emissive systems include encapsulated electrophoretic displays (in which particles migrate within a dielectric fluid under the influence of an electric field); electrically or magnetically driven rotating-ball displays as disclosed in U.S. Pat. Nos. 5,604,027 and 4,419,383, which are incorporated herein by reference in their entirety; and encapsulated displays based on micromagnetic or electrostatic particles as disclosed in U.S. Pat. Nos. 4,211,668, 5,057,363 and 3,683,382, which are incorporated herein by reference in their entirety. A preferred particle non-emissive system is based on discrete, microencapsulated electrophoretic elements, examples of which are disclosed in U.S. Pat. No. 5,930,026 by Jacobson et al. which is incorporated herein by reference in its entirety.

In one embodiment, the present invention relates to directly printing conductive features, such as electrical interconnects and electrodes for addressable, reusable, paper-like visual displays. Examples of paper-like visual displays include “gyricon” (or twisting particle) displays and forms of electronic paper such as particulate electrophoretic displays (available from E-ink Corporation, Cambridge, Mass.). A gyricon display is an addressable display made up of optically anisotropic particles, with each particle being selectively rotatable to present a desired face to an observer. For example, a gyricon display can incorporate “balls” where each ball has two distinct hemispheres, one black and the other white. Each hemisphere has a distinct electrical characteristic (e.g., zeta potential with respect to a dielectric fluid) so that the ball is electrically as well as optically anisotropic. The balls are electrically dipolar in the presence of a dielectric fluid and are subject to rotation. A ball can be selectively rotated within its respective fluid-filled cavity by application of an electric field, so as to present either its black or white hemisphere to an observer viewing the surface of the sheet.

In another embodiment, the present invention relates to electrical interconnects and electrodes for organic light emitting displays (OLEDs). Organic light emitting displays are emissive displays consisting of a transparent substrate coated with a transparent conducting material (e.g., ITO), one or more organic layers and a cathode made by evaporating or sputtering a metal of low work function characteristics (e.g., calcium or magnesium). The organic layer materials are chosen so as to provide charge injection and transport from both electrodes into the electroluminescent organic layer (EL), where the charges recombine to emit light. There may be one or more organic hole transport layers (HTL) between the transparent conducting material and the EL, as well as one or more electron injection and transporting layers between the cathode and the EL. The inks according to the present invention allow the direct deposition of metal electrodes onto low temperature substrates such as flexible large area plastic substrates that are particularly preferred for OLEDs. For example, a metal precursor composition (first ink) can be ink-jet printed and heated at 150° C. to form a 150 μm by 150 μm square electrode with excellent adhesion and a sheet resistivity value of less than 1 ohm per square. The compositions and printing methods of the present invention also enable printing of row and column address lines for OLEDs. These lines can be printed with a thickness of about one μm and a line width of 100 μm using ink-jet printing. These data lines can be printed continuously on large substrates with an uninterrupted length of several meters. Surface modification can be employed, as is discussed above, to confine the ink(s) and to enable printing of such lines as narrow as 10 μm. The printed ink lines can be heated to 150° C. and form metal lines with a bulk conductivity that is no less than 5 percent of the conductivity of the equivalent pure metal.

In one embodiment, the present invention relates to electrical interconnects and electrodes for liquid crystal displays (LCDs), including passive-matrix and active-matrix. Particular examples of LCDs include twisted nematic (TN), supertwisted nematic (STN), double supertwisted nematic (DSTN), retardation film supertwisted nematic (RFSTN), ferroelectric (FLCD), guest-host (GHLCD), polymer-dispersed (PD), and polymer network (PN).

Thin film transistors (TFTs) are well known in the art, and are of considerable commercial importance. Amorphous silicon-based thin film transistors are used in active matrix liquid crystal displays. One advantage of thin film transistors is that they are inexpensive to make, both in terms of the materials and the techniques used to make them. In addition to making the individual TFTs as inexpensively as possible, it is also desirable to inexpensively make the integrated circuit devices that utilize TFTs. Accordingly, inexpensive methods for fabricating integrated circuits with TFTs, such as those of the present invention, are an enabling technology for printed logic.

For many applications, inorganic interconnects are not adequately conductive to achieve the desired switching speeds of an integrated circuit due to high RC time constants. Printed pure metals, as enabled by the inks and processes of the present invention, achieve the required performance. A metal interconnect printed by using a silver precursor composition as disclosed in the present invention will result in a reduction of the resistance (R) and an associated reduction in the time constant (RC) by a factor of 100,000, more preferably by 1,000,000, as compared to current conductive polymer interconnect material used to connect polymer transistors.

Field-effect transistors (FETs), with organic semiconductors as active materials, are the key switching components in contemplated organic control, memory, or logic circuits, also referred to as plastic-based circuits. An expected advantage of such plastic electronics is the ability to fabricate them more easily than traditional silicon-based devices. Plastic electronics thus provide a cost advantage in cases where it is not necessary to attain the performance level and device density provided by silicon-based devices. For example, organic semiconductors are expected to be much more readily printable than vapor-deposited inorganics, and are also expected to be less sensitive to air than recently proposed solution-deposited inorganic semiconductor materials. For these reasons, there have been significant efforts expended in the area of organic semiconductor materials and devices.

Organic thin film transistors (TFTs) are expected to become key components in the plastic circuitry used in display drivers of portable computers and pagers, and memory elements of transaction cards and identification tags. A typical organic TFT circuit contains a source electrode, a drain electrode, a gate electrode, a gate dielectric, an interlayer dielectric, electrical interconnects, a substrate, and semiconductor material. The inks of the present invention can be used to deposit all the components of this circuit, with the exception of the semiconductor material.

One of the most significant factors in bringing organic TFT circuits into commercial use is the ability to deposit all the components on a substrate quickly, easily and inexpensively as compared with silicon technology (i.e., by reel-to-reel printing). The inks of the present invention enable the use of low cost deposition techniques, such as ink-jet printing, for depositing these components.

The inks and processes of the present invention are particularly useful for the direct printing of electrical connectors as well as antennae of smart tags, smart labels, and a wide range of identification devices such as radio frequency identification (RFID) tags. In a broad sense, the inks and processes of the present invention can be utilized to electrically connect semiconductor radio frequency transceiver devices to antenna structures and particularly to radio frequency identification device assemblies. A radio frequency identification device (“RFID”) by definition is an automatic identification and data capture system comprising readers and tags. Data is transferred using electric fields or modulated inductive or radiating electromagnetic carriers. RFID devices are becoming more prevalent in such configurations as, for example, smart cards, smart labels, security badges, and livestock tags.

The inks and processes of the present invention also enable the low cost, high volume, highly customizable production of electronic labels. Such labels can be formed in various sizes and shapes for collecting, processing, displaying and/or transmitting information related to an item in human or machine readable form. The inks and processes of the present invention can also be used to print the conductive features required to form the logic circuits, electronic interconnections, antennae, and display features in electronic labels. The electronic labels can be an integral part of a larger printed item such as a lottery ticket structure with circuit elements disclosed in a pattern as disclosed in U.S. Pat. No. 5,599,046.

In another embodiment of the present invention, the conductive patterns made in accordance with the present invention can be used as electronic circuits for making photovoltaic panels. Currently, conventional screen-printing is used in mass scale production of solar cells. Typically, the top contact pattern of a solar cell consists of a set of parallel narrow finger lines and wide collector lines deposited essentially at a right angle to the finger lines on a semiconductor substrate or wafer. Such front contact formation of crystalline solar cells is performed with standard screen-printing techniques. Direct printing of these contacts with the inks of the present invention provides the advantages of production simplicity, automation, and low production cost.

Low series resistance and low metal coverage (low front surface shadowing) are basic requirements for the front surface metallization in solar cells. Minimum metallization widths of 100 to 150 μm are obtained using conventional screen-printing. This causes a relatively high shading of the front solar cell surface. In order to decrease the shading, a large distance between the contact lines, e.g., 2 to 3 mm, is required. On the other hand, this implies the use of a highly doped, conductive emitter layer. However0, the heavy emitter doping induces a poor response to short wavelength light. Narrower conductive lines can be printed using the inks and printing methods of the present invention. The inks and processes of the present invention enable direct printing of finer features down to 20 μm. The inks and processes of the present invention further enable the printing of pure metals with resistivity values of the printed features as low as 2 times bulk resistivity after processing at temperatures as low as or lower than 200° C.

The low processing and direct-write deposition capabilities according to the present invention are particularly enabling for large area solar cell manufacturing on organic and flexible substrates. This is particularly useful in manufacturing novel solar cell technologies based on organic photovoltaic materials such as organic semiconductors and dye sensitized solar cell technology as disclosed in U.S. Pat. No. 5,463,057 by Graetzel et al. The inks of the present invention can be directly printed and heated to yield a bulk conductivity that is no less than 10 percent of the conductivity of the equivalent pure metal, and achieved by heating the printed features at temperatures below 200° C. on polymer substrates such as plexiglass (PMMA).

Another embodiment of the present invention enables the production of an electronic circuit for making printed wiring board (PWBs) and printed circuit boards (PCBs). In conventional subtractive processes used to make printed-wiring boards, wiring patterns are formed by preparing pattern films. The pattern films are prepared by means of a laser plotter in accordance with wiring pattern data outputted from a CAD (computer-aided design system), and are etched on copper foil by using a resist ink or a dry film resist.

In such conventional processes, it is necessary to first form a pattern film, and to prepare a printing plate in the case when a photo-resist ink is used, or to take the steps of lamination, exposure and development in the case when a dry film resist is used.

Such methods can be said to be methods in which the digitized wiring data are returned to an analog image-forming step. Screen-printing has a limited work size because of the printing precision of the printing plate. The dry film process is a photographic process and, although it provides high precision, it requires many steps, resulting in a high cost especially for the manufacture of small lots.

The inks and processes of the present invention offer solutions to overcome the limitations of the current PWB formation process. For example, they generate very little, if any, waste. The printing methods of the present invention are compatible with small-batch and rapid turn around production runs.

While various embodiments of the present invention have been described in detail, it is apparent that modifications and adaptations of those embodiments will occur to those skilled in the art. It is to be expressly understood, however, that such modifications and adaptations are within the spirit and scope of the present invention.

We claim:

1. A process for forming a conductive feature, wherein the process comprises the steps of:
(a) applying a first ink comprising a metal precursor to at least a portion of a first substrate to form an at least partially coated substrate; and
(b) contacting the first ink with a primary reducing agent under conditions effective to reduce the metal in the metal precursor to its elemental form.

2. The process of claim 1, wherein the process further comprises the steps of:
(c) applying a second ink comprising the primary reducing agent or a solution thereof, before step (a), to at least a portion of a surface of an initial substrate; and
(d) at least partially drying the second ink on the initial substrate to form the first substrate, wherein the first substrate has the primary reducing agent disposed thereon.

3. The process of claim 2, wherein the first ink is selectively applied to the first substrate in a predetermined pattern in step (a).

4. The process of claim 2, wherein the second ink is selectively applied to the initial substrate in a predetermined pattern in step (c).

5. The process of claim 4, wherein the first ink is selectively applied to the first substrate in a predetermined pattern in step (a).

6. The process of claim 1, wherein the first ink is selectively applied to the first substrate in a predetermined pattern in step (a).

7. The process of claim 1, wherein steps (a) and (b) occur simultaneously.

8. The process of claim 1, wherein steps (a) and (b) occur sequentially.

9. The process of claim 1, wherein the metal precursor comprises a metal nitrate or a metal carboxylate.

10. The process of claim 1, wherein the metal precursor comprises silver nitrate or a silver carboxylate

11. The process of claim 1, wherein the metal precursor comprises copper nitrate or a copper carboxylate.

12. The process of claim 1, wherein the metal precursor comprises nickel nitrate or a nickel carboxylate.

13. The process of claim 1, wherein the first ink further comprises metal nanoparticles in an amount from about 1 volume percent to about 60 volume percent, based on the total volume of the first ink.

14. The process of claim 13, wherein the first ink further comprises metal nanoparticles in an amount from about 10 volume percent to about 60 volume percent, based on the total volume of the first ink.

15. The process of claim 14, wherein the first ink further comprises metal nanoparticles in an amount from about 30 volume percent to about 40 volume percent, based on the total volume of the first ink.

16. The process of claim 13, wherein the weight ratio of the metal in the metal precursor to the metal in the metal nanoparticles is from about 0.2 to about 1.0.

17. The process of claim 1, wherein the first ink further comprises silver nanoparticles.

18. The process of claim 1, wherein the first ink further comprises copper nanoparticles.

19. The process of claim 1, wherein the first ink further comprises nickel nanoparticles.

20. The process of claim 1, wherein the first ink further comprises one or more of particulate carbon, carbon black, modified carbon black, carbon nanotubes and/or carbon flakes.

21. The process of claim 1, wherein the first ink further comprises a solvent selected from the group consisting of alcohols, amines, amides, water, ketones, ethers, aldehydes, alkenes, and hydrocarbons, and wherein the solvent is less capable than the primary reducing agent of reducing the metal in the metal precursor to its elemental form.

22. The process of claim 1, wherein the primary reducing agent is selected from the group consisting of alcohols, aldehydes, amines, amides, alanes, boranes, borohydrides, aluminohydrides and organosilanes.

23. The process of claim 1, wherein the first substrate comprises a component selected from the group consisting of an organic substrate, a glass substrate, a ceramic substrate, paper, and a polymeric substrate.

24. The process of claim 1, wherein the first ink has a viscosity of not greater than about 100 centipoise.

25. The process of claim 24, wherein the first ink has a viscosity of not greater than about 60 centipoise.

26. The process of claim 25, wherein the first ink has a viscosity of not greater than about 40 centipoise.

27. The process of claim 1, wherein the first ink has a surface tension of from about 15 dynes/cm to about 72 dynes/cm.

28. The process of claim 27, wherein the first ink has a surface tension of from about 20 dynes/cm to about 60 dynes/cm.

29. The process of claim 1, wherein step (a) comprises ink jetting the first ink onto the first substrate to form the at least partially coated substrate.

30. The process of claim 1, wherein step (a) comprises applying the first ink to the first substrate with a printing process selected from the group consisting of: intaglio printing, gravure printing, lithographic printing, and flexographic printing.

31. The process of claim 1, wherein the conductive feature has a linear form and has a width of less than about 200 μm.

32. The process of claim 1, wherein steps (a) and (b) occur at less than about 200° C.

33. The process of claim 1, wherein at least 95 weight percent of the metal in the metal precursor is reduced to its elemental form in less than 1 second.

34. The process of claim 1, wherein the first substrate comprises a reducing agent layer and an underlying support layer, wherein the reducing agent layer comprises the primary reducing agent and has an external surface, and wherein the first ink is applied to at least a portion of the external surface in step (a).

35. The process of claim 1, wherein the first ink comprises the metal in the metal precursor in an amount greater than about 10 weight percent, based on the total weight of the first ink.

36. The process of claim 1, wherein the surface tension of the primary reducing agent is less than the surface tension of the first ink.

37. The conductive feature formed by the process of claim 1.

38. The conductive feature of claim 37, wherein the conductive feature has a resistivity of no greater than 500 times the resistivity of the bulk metal.

39. The conductive feature of claim 37, wherein the conductive feature has a resistivity of no greater than 100 times the resistivity of the bulk metal.

40. The conductive feature of claim 37, wherein the conductive feature has a resistivity of no greater than 10 times the resistivity of the bulk metal.

41. The conductive feature of claim 37, wherein the conductive feature comprises an insulating phase and has a resistivity of from about 1,000 μΩ-cm to about 1,000,000 μΩ-cm.

42. The conductive feature of claim 37, wherein the conductive feature comprises an insulating phase and has a resistivity of from about 10,000 μΩ-cm to about 1,000,000 μΩ-cm.

43. The process of claim 1, wherein the process further comprises the step of:
(c) applying a second ink comprising the primary reducing agent to at least a portion of the at least partially coated substrate after step (a).

44. The process of claim 43, wherein the second ink is selectively applied to the at least partially coated substrate in a predetermined pattern in step (c).

45. The process of claim 43, wherein the second ink applied in step (c) at least partially overlaps the first ink.

46. The process of claim 43, wherein the first ink is selectively applied to the first substrate in a first predetermined pattern in step (a).

47. The process of claim 46, wherein a second ink comprising the primary reducing agent is selectively applied to the at least partially coated substrate in a second predetermined pattern in step (c).

48. The process of claim 43, wherein the second ink further comprises metal nanoparticles in an amount from about 1 volume percent to about 60 volume percent, based on the total volume of the second ink.

49. The process of claim 48, wherein the second ink further comprises metal nanoparticles in an amount from about 5 volume percent to about 60 volume percent, based on the total volume of the second ink.

50. The process of claim 48, wherein the second ink further comprises metal nanoparticles in an amount from about 5 volume percent to about 30 volume percent, based on the total volume of the second ink.

51. The process of claim 43, wherein the second ink further comprises a cap stripping agent.

52. The process of claim 43, wherein the second ink further comprises a flocculent.

53. The process of claim 43, wherein the first ink has a pH of less than 7 and the second ink has a pH of greater than 7.

54. The process of claim 43, wherein the first ink has a pH of greater than 7 and the second ink has a pH of less than 7.

55. The process of claim 43, wherein the second ink further comprises silver nanoparticles.

56. The process of claim 43, wherein the second ink further comprises copper nanoparticles.

57. The process of claim 43, wherein the second ink further comprises nickel nanoparticles.

58. The process of claim 43, wherein the second ink further comprises one or more of particulate carbon, carbon black, modified carbon black, carbon nanotubes and/or carbon flakes.

59. The process of claim 43, wherein the second ink further comprises a solvent selected from the group consisting of alcohols, amines, amides, water, ketones, ethers, aldehydes, alkenes, and hydrocarbons, and wherein the solvent is less capable than the primary reducing agent of reducing the metal in the metal precursor to its elemental form.

60. The process of claim 43, wherein the second ink has a viscosity of not greater than about 100 centipoise.

61. The process of claim 43, wherein the second ink has a viscosity of not greater than about 60 centipoise.

62. The process of claim 43, wherein the second ink has a viscosity of not greater than about 40 centipoise.

63. The process of claim 43, wherein the second ink has a surface tension of from about 15 dynes/cm to about 72 dynes/cm.

64. The process of claim 43, wherein the second ink has a surface tension of from about 20 dynes/cm to about 60 dynes/cm.

65. The process of claim 43, wherein step (c) comprises ink jetting the second ink onto the at least partially coated substrate.

66. The process of claim 43, wherein step (c) comprises applying the second ink to the at least partially coated substrate with a printing process selected from the group consisting of:
intaglio printing, gravure printing, lithographic printing, and flexographic printing.

67. The conductive feature formed by the process of claim 43.

68. The conductive feature of claim 67, wherein the conductive feature has a resistivity of no greater than 500 times the resistivity of the bulk metal.

69. The conductive feature of claim 67, wherein the conductive feature has a resistivity of no greater than 100 times the resistivity of the bulk metal.

70. The conductive feature of claim 67, wherein the conductive feature has a resistivity of no greater than 10 times the resistivity of the bulk metal.

71. The conductive feature of claim 67, wherein the conductive feature comprises an insulating phase and has a resistivity of from about 1,000 μΩ-cm to about 1,000,000 μΩ-cm.

72. The conductive feature of claim 67, wherein the conductive feature comprises an insulating phase and has a resistivity from about 10,000 μΩ-cm to about 1,000,000 μΩ-cm.

73. The process of claim 1, wherein the process further comprises the step of:
(c) applying a second ink comprising the primary reducing agent to an initial substrate, prior to step (a), to form the first substrate.

74. The process of claim 73, wherein the second ink is selectively applied to the initial substrate in a predetermined pattern in step (c).

75. The process of claim 73, wherein the first ink applied in step (a) at least partially overlaps the second ink.

76. The process of claim 73, wherein the first ink is selectively applied to the first substrate in a first predetermined pattern in step (a).

77. The process of claim 76, wherein a second ink comprising the primary reducing agent is selectively applied to the initial substrate in a second predetermined pattern in step (c).

78. The process of claim 73, wherein the second ink further comprises metal nanoparticles in an amount from about 1 volume percent to about 60 volume percent, based on the total volume of the second ink.

79. The process of claim 78, wherein the second ink further comprises metal nanoparticles in an amount from about 10 volume percent to about 60 volume percent, based on the total volume of the second ink.

80. The process of claim 78, wherein the second ink further comprises metal nanoparticles in an amount from about 30 volume percent to about 40 volume percent, based on the total volume of the second ink.

81. The process of claim 73, wherein the second ink further comprises a cap stripping agent.

82. The process of claim 73, wherein the second ink further comprises a flocculent.

83. The process of claim 73, wherein the first ink has a pH of less than 7 and the second ink has a pH of greater than 7.

84. The process of claim 73, wherein the first ink has a pH of greater than 7 and the second ink has a pH of less than 7.

85. The process of claim 73, wherein the second ink further comprises silver nanoparticles.

86. The process of claim 73, wherein the second ink further comprises copper nanoparticles.

87. The process of claim 73, wherein the second ink further comprises nickel nanoparticles.

88. The process of claim 73, wherein the second ink further comprises one or more of particulate carbon, carbon black, modified carbon black, carbon nanotubes and/or carbon flakes.

89. The process of claim 73, wherein the second ink further comprises a solvent selected from the group consisting of alcohols, amines, amides, water, ketones, ethers, aldehydes, alkenes, and hydrocarbons, and wherein the solvent is less capable than the primary reducing agent of reducing the metal in the metal precursor to its elemental form.

90. The process of claim 73, wherein the second ink has a viscosity of not greater than about 100 centipoise.

91. The process of claim 73, wherein the second ink has a viscosity of not greater than about 60 centipoise.

92. The process of claim 73, wherein the second ink has a viscosity of not greater than about 40 centipoise.

93. The process of claim 73, wherein the second ink has a surface tension of from about 15 dynes/cm to about 72 dynes/cm.

94. The process of claim 73, wherein the second ink has a surface tension of from about 20 dynes/cm to about 60 dynes/cm.

95. The process of claim 73, wherein step (c) comprises ink jetting the second ink onto the initial substrate.

96. The process of claim 73, wherein step (c) comprises applying the second ink to the initial substrate with a printing process selected from the group consisting of: intaglio printing, gravure printing, lithographic printing, and flexographic printing.

97. The conductive feature formed by the process of claim 73.

98. The conductive feature of claim 97, wherein the conductive feature has a resistivity of no greater than 500 times the resistivity of the bulk metal.

99. The conductive feature of claim 97, wherein the conductive feature has a resistivity of no greater than 100 times the resistivity of the bulk metal.

100. The conductive feature of claim 97, wherein the conductive feature has a resistivity of no greater than 10 times the resistivity of the bulk metal.

101. The conductive feature of claim 97, wherein the conductive feature comprises an insulating phase and has a resistivity of from about 1,000 μΩ-cm to about 1,000,000 μΩ-cm.

102. The conductive feature of claim 97, wherein the conductive feature comprises an insulating phase and has a resistivity of from about 10,000 μΩ-cm to about 1,000,000 μΩ-cm.

103. A reducing agent composition suitable for ink jetting, the reducing agent composition comprising a primary reducing agent dissolved in a solvent, wherein the reducing agent composition is capable of reducing a metal in a metal precursor to its elemental form, and wherein the reducing agent composition has a surface tension of from about 15 to about 72 dynes/cm and a viscosity of not greater than about 1000 centipoise.

104. The reducing agent composition of claim 103, where the reducing agent composition consists essentially of the primary reducing agent dissolved in the solvent.

105. The reducing agent composition of claim 103, wherein the reducing agent composition has a pH of from about 5 to about 7.

106. The reducing agent composition of claim 103, wherein the reducing agent composition has a pH of from about 7 to about 9.

107. The reducing agent composition of claim 103, further comprising metal nanoparticles in an amount from about 1 volume percent to about 60 volume percent, based on the total volume of the reducing agent composition.

108. The reducing agent composition of claim 103, further comprising silver nanoparticles.

109. The reducing agent composition of claim 103, further comprising copper nanoparticles.

110. The reducing agent composition of claim 103, further comprising one or more of particulate carbon, carbon black, modified carbon black, carbon nanotubes and/or carbon flakes.

111. The reducing agent composition of claim 103, further comprising a cap stripping agent.

112. The reducing agent composition of claim 103, further comprising a flocculent.

113. The reducing agent composition of claim 103, wherein the primary reducing agent is selected from the group consisting of alcohols, aldehydes, amines, amides, alanes, boranes, borohydrides, aluminohydrides and organosilanes.

114. The reducing agent composition of claim 103, wherein the solvent is selected from the group consisting of alcohols, amines, amides, water, ketones, ethers, aldehydes and alkenes.

115. A substrate suitable for receiving an ink jetted ink, the substrate comprising:
(a) a support material having a surface; and
(b) a primary reducing agent disposed over at least a portion of the surface.

116. The substrate of claim 115, wherein the primary reducing agent is disposed over a majority of the surface.

117. The substrate of claim 115, wherein the primary reducing agent is selectively disposed in a pattern over the portion of the surface.

118. The substrate of claim 115, wherein the support material has opposing major planar surfaces, and the primary reducing agent is disposed over a majority of one of the opposing major planar surfaces.

119. The substrate of claim 118, wherein the support material comprises paper.

120. The substrate of claim 118, wherein the primary reducing agent is disposed over at least 90 percent of one of the opposing major planar surfaces.

121. The substrate of claim 118, wherein the primary reducing agent is disposed over at least 90 percent of both of the opposing major planar surfaces.

122. The substrate of claim 115, wherein the substrate is dry.

123. The substrate of claim 115, wherein the primary reducing agent is selected from the group consisting of alcohols, aldehydes, amines, amides, alanes, boranes, borohydrides, aluminohydrides and organosilanes.

124. The substrate of claim 115, wherein the support material is selected from the group consisting of paper, cardboard, glass and plastic.

125. The substrate of claim 115, wherein the primary reducing agent has a molecular weight greater than about 500.
